(19) United States
(12) Patent Application Publication
(10) Pub. No.: US 2015/0081161 A1
(43) Pub. Date: Mar. 19, 2015

(54) SYSTEMS, ARTICLE AND METHODS FOR MANAGING VEHICLE LOGISTICS INCLUDING AUTHORED CONTENT GENERATION, APPROVAL, AND DISTRIBUTION

(71) Applicant: Tweddle Group, Clinton Township, MI (US)

(72) Inventors: Gerry Chapman, Detroit, MI (US); Dan Forkin, Southfield, MI (US)

(21) Appl. No.: 14/485,419

(22) Filed: Sep. 12, 2014

Related U.S. Application Data
(60) Provisional application No. 61/877,646, filed on Sep. 13, 2013.

(51) Int. Cl. G07C 5/00

(52) U.S. Cl. CPC G07C 5/008
USPC 701/31.5

(57) ABSTRACT

A system for managing vehicle logistics including authored content generation, approval, and distribution to remote user portable devices can include one or more back-end systems to process and track authored content through a content approval process and distribute authored content to the portable devices based upon one or more parameters. Such parameters may include one or more vehicle makes and/or models logically associated with the portable device. The system may include an auditing system to ensure the most recent authored content is present on a user's portable device. The system may further include data collection and diagnostics system able to provide maintenance or repair instructions based on reported vehicle data. A parts and materials inventory logistics system and a vehicle deployment system may ensure prompt delivery of parts and materials to repair locations and ensure prompt delivery of replacement vehicles for unrepairable or out-of-service vehicles.

### BACKGROUND

1. Technical Field

The present disclosure generally relates to composition and delivery of informational content related to one or more items of manufacture, more specifically the present disclosure relates to delivering such informational content using a portable electronic device accompanying the item of manufacture.

2. Description of the Related Art

Logistical or supply chain structures involve the acquisition, storage, transport, and supply of commodities and raw materials within an organization. For simple and/or relatively small organizations, supply chain management is complex and frequently requires the use of one or more systems dedicated to supply chain logistics to ensure the smooth operation of the organization. For larger and/or more complex organizations such as large commercial entities, governmental agencies, and military organizations, supply chain logistics represent an important part of not only keeping the organization functioning, but also of improving the speed, efficiency, cost control, and responsiveness of the organization.

For many organizations, the supply chain structure includes the necessary staffing and infrastructure to ensure equipment (e.g., uniforms, forklifts, trucks, aircraft), consumables (e.g., food, fuel, parts), and a service organization (e.g., manuals, training, policies, procedures) to repair and maintain the equipment is available in the necessary volume and in the appropriate locations. For a commercial organization, streamlined and efficient supply chain logistics can assist in providing customers and clients products and services at the lowest cost. For a military organization, streamlined and efficient supply chain logistics can advantageously increase the responsiveness and ability of the organization to respond quickly and efficiently on either a short or long term basis in remote regions of the world.

More complex assets such as trucks, all-terrain vehicles, specialized equipment, and the like require significant maintenance to ensure a high level of equipment availability and maximize reliability. For large, diverse organizations such as military organizations, standardized documents, training, and procedures reviewed and approved for distribution by an administrative agency and authorized for use throughout all or a portion of the organization ensure the use of similar or common practices and procedures by all personnel. Such maintenance and service procedures improve the responsiveness of the organization since equipment, crew, and support personnel are individually assignable.

Within many organizations, training and documentation change frequently to reflect changing conditions and circumstances as well as to reflect previously unforeseeable events and conditions. Prior to “rolling out” such changes, many fleet operators impose a formal review and approval processes. Thus, in addition to supply chain logistical issues, many organizations, particularly governmental and military organizations impose a relatively complex, formal, approval structure on the distribution of documentation related to the maintenance and repair of vehicles and equipment. When combined with routine or typical changes that occur in vehicles and equipment throughout a production run, many organizations would benefit from an integrated management system able to track supply chain logistics, document preparation and approval, and document distribution to appropriate operating and maintenance personnel.

### BRIEF SUMMARY

### Modern Equipment

To reduce the volume of documentation required to support the field repair and maintenance of vehicles such as military vehicles portable electronic devices such as tablet computers can replace and/or augment more traditional, printed, service, maintenance and repair documentation. The use of portable electronic devices offers several advantages including a significant reduction in the weight and volume of documentation needed to field repair and maintain vehicles and equipment. Additionally, electronic documentation supports the presentation of maintenance and repair information in machine executable formats such as animations, audio, video, and audio/visual presentations heretofore impossible to include in printed documentation. Finally, the use of portable electronic devices permits the near instantaneous bi-directional transmission of information from the field to a back-end system and from the back-end system to the field, when a communications channel is available and the vehicle is not operating in a radio silence mode. Such information can include the transmission of data indicative of vehicle system and/or vehicle condition by a field portable device to a back-end system. Such information may also include the transmission of analytical data, parts and/or materials availability, and location information from the back-end system to the field portable device. Such information may additionally include the transmission of up-to-date checklists and/or instruction sets relevant to the vehicles associated with a particular portable device from the back-end system to the respective portable device.

Each portable device assigned to a vehicle crewmember or field maintenance technician is logically associated with a number of vehicles that may be of the same make and model or may be of different makes and/or models. Each vehicle carries vehicle identification information that uniquely identifies the vehicle. Responsive to receiving data indicative of a vehicle identifier, the portable device can cause one or more checklists and/or instruction sets to appear on a display device. The portable device receives vehicle system data either autonomously via a tethered (e.g., wire, optical fiber) or wireless (e.g., RF, microwave, radio, transmitter, receiver, transceiver) connection to the respective vehicle or manually via input provided by the vehicle crewmember or maintenance technician assigned to the respective vehicle.

Vehicle system and/or condition data received by the portable device is stored at least temporarily within a nontransitory memory or non-volatile storage device. The portable device transmits vehicle system and/or condition data to a remote recipient such as a back end system where the data can be analyzed, actual or potential maintenance or repair issues identified, and parts and materials needed for maintenance and repair of the vehicle dispatched to a defined location. Additionally, where maintenance and repair instructions are not stored locally on the portable device, the back-end system can communicate the maintenance and repair instructions to the portable device.

Vehicle related authored assets include the aforementioned checklists and/or instruction sets as well as other maintenance, repair and operational information provided by vehicle manufacturers and/or equipment suppliers. Vehicle manufacturers and/or equipment suppliers supply such vehicle related authored assets in electronic format or in a physical format that is convertible to an electronic format, for example through scanning and/or optical character recognition. Within the vehicle fleet operator's organization, formal review and approval processes occur prior to distributing the vehicle related authored assets to crewmembers and/or field maintenance technicians.

The back-end system can include an Authoring Versioning Approval System that tracks the formal review and approval of the vehicle related authored assets by the fleet operator's organization. An Authored Content Distribution System then distributes the approved vehicle related authored assets to the portable devices associated with vehicle crewmembers and field maintenance technicians assigned to a particular vehicle. An Auditing System monitors the checklists and/or instruction sets on each of the portable devices to ensure the most recent versions relevant to the vehicles associated with each portable device are loaded on the respective portable device. The back-end system also includes a Vehicle Deployment Positioning System to locate and dispatch replacement equipment and/or vehicles to defined locations to replace vehicles as determined by the back-end system.

A vehicle operation tablet computer device may be summarized as including a control subsystem including at least one processor and at least one nontransitory processor-readable medium communicatively coupled to the at least one processor; a user interface subsystem communicatively coupled to the control subsystem, the user interface subsystem including at least one input device; and a communications subsystem communicatively coupled to the control subsystem, the communications subsystem operable to selectively provide communications with at least one external device, the control subsystem causes the user interface subsystem to provide at least one checklist which is specific to a make and model of the vehicle, stores information received via the checklist and the user interface subsystem, and the communications subsystem selectively transmits the stored information logically associated with a unique vehicle identifier that uniquely identifies the vehicle.

The communications subsystem may selectively transmit the stored information logically associated with a unique user identifier that uniquely identifies a user of the vehicle operation tablet computer device. The control subsystem may determine a role of a user of the vehicle operation tablet computer device, and may select the checklist from a library of checklists based at least in part on the determined role of the user. The control subsystem may determine the role of a user of the vehicle operation tablet computer device from a set of roles including vehicle operator, vehicle technician, and mechanic. The control subsystem may determine the role of a user of the vehicle operation tablet computer device from at least one input by the user. The control subsystem may determine the role of a user of the vehicle operation tablet computer device from at least one automatically sensed parameter (e.g., RFID, biometric) indicative of an identity of the user of the vehicle operation tablet computer device. The at least one input device may include at least one touch-sensitive display, which in use displays at least one user interface component. The at least one user interface component may include at least one of a selectable icon or text. The at least one user interface component may include at least one fillable form. The communications subsystem may transmit the stored information logically associated with the unique vehicle identifier when both: a) a wireless communications connection is available via the communications subsystem, and b) the vehicle is not in a radio dark mode. The communications subsystem may transmit the stored information logically associated with the unique vehicle/equipment identifier when a tethered communications connection is available via the communications subsystem. The control subsystem may cause the user interface subsystem to provide a synchronization message. The control subsystem may cause the user interface subsystem to provide the synchronization message in response to detection of a tethered or untethered communications channel accessible via the communications subsystem. The control subsystem may cause the user interface subsystem to provide the synchronization message in response to a scheduled synchronization. The control subsystem may cause the user interface subsystem to provide the synchronization message in response to a period between a current date and a most recent synchronization exceeding a threshold value. The control subsystem may cause the user interface subsystem to provide the synchronization message in response to both a) a period between a current date and a most recent synchronization exceeding a threshold value, and b) a tethered or untethered communications channel is accessible via the communications subsystem. The control subsystem may delete the stored information from the nontransitory processor-readable medium after the communications subsystem transmits the information. The control subsystem may lock the stored information in the nontransitory processor-readable medium from changes in response to an event. The communications subsystems may receive signals indicative of one or more automatically sensed conditions of the vehicle, and the communications subsystem may automatically transmit information indicative of the automatically sensed conditions of the vehicle externally from the vehicle operation tablet computer device. The communications subsystems may receive signals indicative of one or more automatically sensed conditions of the vehicle, and the control subsystem may automatically populate at least a portion of the checklist based at least in part on the automatically sensed conditions of the vehicle. The communications subsystems may receive the signals from a controller area network (CAN) bus of the vehicle. Communications subsystems may receive the signals from at least one transceiver that is directly communicatively coupled to a controller area network (CAN) bus of the vehicle. The signals may be indicative of at least one of: an engine speed, an engine temperature, an oil pressure of the vehicle. The signals may be indicative of at least one of: an ambient environmental characteristic at least proximate the vehicle.

A method of operating a vehicle operation tablet computer device may be summarized as including identifying a vehicle make and a vehicle model on a vehicle operation tablet computing device; generating by the vehicle operation tablet computing device a user interface, the user interface including at least one vehicular checklist specific to the identified vehicular make and the identified vehicular model; receiving one or more inputs by the vehicle operation tablet computing device, the one or more inputs including data indicative of information provided responsive to the at least one vehicular checklist; storing in a nontransitory storage medium communicably coupled to the vehicle operation tablet computing device the received data indicative of information provided responsive to the at least one vehicular checklist; and transmitting the stored data indicative of information provided responsive to the at least one vehicular checklist along with data representative of a unique vehicle identifier that uniquely identifies a vehicle logically associated with the at least one vehicular checklist to one or more remote recipient devices.

The method may further include selectively transmitting information logically associated with a unique user identifier that uniquely identifies a user of the vehicle operation tablet computer device. Generating at least one vehicular checklist specific to the identified vehicular make and the identified vehicular model may include determining a role of a user of the vehicle operation tablet computer device; and selecting the vehicular checklist specific to the identified vehicular make and the identified vehicular model from a library of checklists based at least in part on the determined role of the user. Determining a role of a user of the vehicle operation tablet computer device may include selecting the role from a set of roles including vehicle operator, vehicle technician, and mechanic. Determining a role of a user of the vehicle operation tablet computer device may include determining the role of a user of the vehicle operation tablet computer device from at least one input by the user. Determining a role of a user of the vehicle operation tablet computer device may include automatically sensing at least one parameter indicative of an identity of the user of the vehicle operation tablet computer device; and determining the role of a user of the vehicle operation tablet computer device based at least in part on the one automatically sensed parameter. Identifying a vehicle make and a vehicle model on a vehicle operation tablet computing device may include identifying the vehicle make and the vehicle model via at least one user interface component presented on at least one touch-sensitive display communicably coupled to the vehicle operation tablet computer device. Identifying the vehicle make and the vehicle model via at least one user interface component presented on at least one touch-sensitive display communicably coupled to the vehicle operation tablet computer device may include selecting the vehicle make and the vehicle model via at least one of a selectable icon or text displayed as a portion of the at least one user interface component presented on at least one touch-sensitive display communicably coupled to the vehicle operation tablet. Identifying the vehicle make and the vehicle model via at least one user interface component presented on at least one touch-sensitive display communicably coupled to the vehicle operation tablet computer device may include providing information to the vehicle operation tablet computer device via at least one fillable form displayed on the user interface. Transmitting the stored data indicative of information provided responsive to the at least one vehicular checklist along with data representative of a unique vehicle identifier that uniquely identifies a vehicle logically associated with the at least one vehicular checklist to one or more remote recipient devices may include transmitting the stored data indicative of information provided responsive to the at least one vehicular checklist along with data representative of a unique vehicle identifier that uniquely identifies a vehicle logically associated with the at least one vehicular checklist when a wireless communications connection is available and the vehicle is not in a radio dark mode. Transmitting the stored data indicative of information provided responsive to the at least one vehicular checklist along with data representative of a unique vehicle identifier that uniquely identifies a vehicle logically associated with the at least one vehicular checklist to one or more remote recipient devices may include transmitting the stored data indicative of information provided responsive to the at least one vehicular checklist along with data representative of a unique vehicle identifier that uniquely identifies a vehicle logically associated with the at least one vehicular checklist when a tethered communications connection is available via the communications subsystem. The method may further include providing a synchronization message. Providing a synchronization message may include detecting by the vehicle operation tablet computer device an accessible tethered or untethered communications channel; and providing the synchronization message responsive to detection of the accessible tethered or untethered communications channel. Providing a synchronization message may include detecting by the vehicle operation tablet computer an indicator indicative of a scheduled synchronization event; and providing the synchronization message responsive to the detected scheduled synchronization event. Providing a synchronization message may include determining by the vehicle operation tablet computer device a difference between data indicative of a current date and data indicative of a most recent synchronization date; and providing the synchronization message responsive to the determined difference between the current date and the most recent synchronization exceeding a defined threshold value. Providing a synchronization message may include determining by the vehicle operation tablet computer device a difference between data indicative of a current date and data indicative of a most recent synchronization date; and providing the synchronization message responsive to the determined difference between the current date and the most recent synchronization exceeding a defined threshold value and detecting of an accessible tethered or untethered communications channel. The method may further include deleting the stored information from the nontransitory processor-readable medium after the communications subsystem transmits the information. The method may further include locking by the vehicle operation tablet computer the stored information in a nontransitory processor-readable medium from changing responsive to the occurrence of an external event. The method may further include receiving by the vehicle operation tablet computer one or more signals including data indicative of one or more automatically sensed conditions of the vehicle; and transmitting by the vehicle operation tablet computer information indicative of the automatically sensed conditions of the vehicle. The method may further include receiving by the vehicle operation tablet computer one or more signals including data indicative of one or more automatically sensed conditions of the vehicle; and automatically populating at least a portion of the at least one vehicular checklist based at least in part on the automatically sensed conditions of the vehicle. Receiving by the vehicle operation tablet computer one or more signals including data indicative of one or more automatically sensed conditions of the vehicle may include receiving by the vehicle operation tablet computer the one or more signals from a controller area network (CAN) bus of the vehicle. Receiving by the vehicle operation tablet computer one or more signals including data indicative of one or more automatically sensed conditions of the vehicle may include receiving by the vehicle operation tablet computer the one or more signals from at least one transceiver that is directly communicatively coupled to a controller area network (CAN) bus of the vehicle. Receiving by the vehicle operation tablet computer one or more signals including data indicative of one or more automatically sensed conditions of the vehicle may include receiving by the vehicle operation tablet computer one or more signals including data indicative of at least one of: an engine speed, an engine temperature, or an oil pressure of the vehicle. Receiving by the vehicle operation tablet computer one or more signals including data indicative of one or more automatically sensed conditions of the vehicle may include receiving by the vehicle operation tablet computer one or more signals including data indicative of at least one ambient environmental characteristic at least proximate the vehicle.

A system to facilitate operation of vehicles may be summarized as including an authoring system, the authoring system including at least one authoring system processor and at least one authoring system nontransitory processor-readable medium communicatively couple to the at least one authoring system processor, and an authoring system communications subsystem operable to selectively provide communications, the at least one authoring system processor operable to generate a number of versions of vehicle related authored content, and to at least temporarily store the versions of vehicle related authored content to the at least one authoring system nontransitory processor-readable medium at least until each version of the vehicle related authored content is approved; and an authored content distribution system, including at least one authored content distribution processor and at least one authored content distribution nontransitory processor-readable medium communicatively coupled to the at least one authored content distribution processor, and an authored content distribution communications subsystem operable to selectively provide networked communications at least with a plurality of end user devices, the authored content distribution processor operable to track approval of versions of the vehicle related authored content and the authored content distribution communications subsystem which provides approved versions of the vehicle related authored content remotely from the authored content distribution system to each of the plurality of end user devices.

The system may further include the plurality of end user devices, each of the end user devices having a respective a control subsystem including at least one processor and at least one nontransitory processor-readable medium communicatively coupled to the at least one processor, a respective a user interface subsystem communicatively coupled to the control subsystem, the user interface subsystem including at least one input device; and a respective communications subsystem communicatively coupled to the control subsystem, the communications subsystem operable to selectively provide communications with at least one external device, the communications subsystem receives vehicle related authored content from time-to-time via the authored content distribution system, and the control subsystem causes the user interface subsystem to present the vehicle related authored content. At least one of the end user devices may be a table computer device and at least one of the end user devices may be a head unit of a vehicle. At least one piece of the vehicle related authored content may include at least one checklist which is specific to a make and model of a vehicle. At least one piece of the vehicle related authored content may include at least one vehicle operation manual. At least one piece of the vehicle related authored content may include at least one vehicle service manual. At least one piece of the vehicle related authored content may include at least one of a textual description, a diagram, an illustration, a picture, an animated sequence, or a video. The system may further include a compliance audit system, the compliance audit system including at least one compliance audit system processor, at least one compliance audit system nontransitory processor-readable medium communicatively coupled to the at least one compliance audit system processor, a compliance audit system communications subsystem operable to provide networked communications at least with the plurality of end user devices, the at least one compliance audit system processor tracks synchronization for each of the plurality of end user devices, and causes the compliance audit system communications subsystem to transmit a notification indicative of a synchronization status. For each of the plurality of end user devices, the at least one compliance audit system processor may determine whether the end user device has synchronized with the authored content distribution system within a scheduled date. For each of the plurality of end user devices, the at least one compliance audit system processor may determine whether the end user device has synchronized with the authored content distribution system within a defined period of time. For each of the plurality of end user devices, the at least one compliance audit system processor may determine whether the end user device has synchronized with the authored content distribution system since an approval of the approved version of the vehicle related authored content. For each of the plurality of end user devices, the at least one compliance audit system processor may determine whether the end user device has stored a most current version of the approved version of the vehicle related authored content. The at least one compliance audit system processor may cause the compliance audit system communications subsystem to transmit a notification to any the end user device which has not synchronized with in a defined time or by a defined date. The at least one compliance audit system processor may cause the compliance audit system communications subsystem to transmit a notification to a logical address associated with a supervisor indicative of any end user device which has not synchronized with in a defined time or by a defined date. The at least one compliance audit system processor may generate a compliance report indicative at least of any end user devices which have not synchronized with in a defined time or by a defined date, and may cause the compliance audit system communications subsystem to transmit the compliance report to a logical address associated with a supervisor. The system may further include a vehicle diagnostics system, the vehicle diagnostics system including at least one vehicle diagnostics system processor, at least one vehicle diagnostics system nontransitory processor-readable medium communicatively coupled to the at least one vehicle diagnostics system processor, and a vehicle diagnostics system communications subsystem operable to provide networked communications at least with the plurality of end user devices, the vehicle diagnostics system communications subsystem which receives information for at least one vehicle, at least one vehicle diagnostics system processor analyzes the received information and generates a result, and the vehicle diagnostics system communications subsystem provides the result of the analysis to at least one of the end user devices. The system may further include a vehicle diagnostics system, the vehicle diagnostics system including at least one vehicle diagnostics system processor, at least one vehicle diagnostics system nontransitory processor-readable medium communicatively coupled to the at least one vehicle diagnostics system processor, and a vehicle diagnostics system communications subsystem operable to provide networked communications at least with the plurality of end user devices, the vehicle diagnostics system communications subsystem which receives information user entered information for a specific vehicle, at least one vehicle diagnostics system processor analyzes the received information and generates a result, and the vehicle diagnostics system communications subsystem provides the result of the analysis to at least one of the end user devices in the form of at least one tutorial indicative of an operation to be performed on the specific vehicle. The system may further include a vehicle diagnostics system, the vehicle diagnostics system including at least one vehicle diagnostics system processor, at least one vehicle diagnostics system nontransitory processor-readable medium communicatively coupled to the at least one vehicle diagnostics system processor, and a vehicle diagnostics system communications subsystem operable to provide networked communications at least with the plurality of end user devices, the vehicle diagnostics system communications subsystem which receives information automatically collected from a specific vehicle, at least one vehicle diagnostics system processor analyzes the received information and generates a result, and the vehicle diagnostics system communications subsystem provides the result of the analysis to at least one of the end user devices in the form of at least one of a piece of vehicle related authored content indicative of an operation to be performed on the specific vehicle or a piece of executable vehicle related authored content for execution by at least one processor of the specific vehicle. The at least one vehicle diagnostics system processor may select vehicle related authored content to be provided based at least in part of a role of an end user logically associated with the end user device which is logically associated with the specific vehicle. The system may further include a parts logistics system, the parts logistics system including at least one parts logistics system processor, at least one parts logistics system nontransitory processor-readable medium communicatively coupled to the at least one parts logistics system processor, and a parts logistics communications subsystem operable to provide networked communications at least with the vehicle diagnostics system, the at least one parts logistics system nontransitory processor-readable medium storing location information for a plurality of vehicle parts, the parts logistics system processor which determines which parts are required for maintenance or repair of a specific vehicle based at least in part on information received from the vehicle diagnostics system, and which causes information to be sent via the parts logistics communications subsystem which specifies at least one of a location or date associated with the parts that are required for maintenance or repair of the specific vehicle. The information to be sent via the parts logistics communications subsystem may be in the form of a request for the parts required for maintenance or repair of the specific vehicle to be sent to a distribution facility, to a repair facility or to an in field location of the specific vehicle. The information to be sent via the parts logistics communications subsystem may specify a specific location in a distribution facility or a repair facility of the parts required for maintenance or repair of the specific vehicle. The information to be sent via the parts logistics communications subsystem may specify a location in transit of the parts required for maintenance or repair of the specific vehicle. The system may further include a parts logistics system, the parts logistics system including at least one parts logistics system processor, at least one parts logistics system nontransitory processor-readable medium communicatively coupled to the at least one parts logistics system processor, and a parts logistics communications subsystem operable to provide networked communications, the at least one parts logistics system nontransitory processor-readable medium storing location information for a plurality of vehicle parts, the parts logistics system processor which determines which parts are required for maintenance or repair of a specific vehicle, and which causes information to be sent via the parts logistics communications subsystem which specifies at least one of a location or date associated with the parts that are required for maintenance or repair of the specific vehicle. The information to be sent via the parts logistics communications subsystem may be in the form of a request for the parts required for maintenance or repair of the specific vehicle to be sent to a distribution facility, to a repair facility or to an in field location of the specific vehicle. The information to be sent via the parts logistics communications subsystem may specify a specific location in a distribution facility or a repair facility of the parts required for maintenance or repair of the specific vehicle. The information to be sent via the parts logistics communications subsystem may specify a location in transit of the parts required for maintenance or repair of the specific vehicle. The system may further include a vehicle deployment system, the vehicle deployment system including at least one vehicle deployment system processor, at least one vehicle deployment system nontransitory processor-readable medium communicatively coupled to the at least one vehicle deployment system processor, and a vehicle deployment communications subsystem operable to provide networked communications, the at least one vehicle deployment system processor determining when a replacement vehicle is required for a specific vehicle that requires repair or maintenance, and which causes the vehicle deployment communications subsystem to provide a request for the replacement vehicle to a system associated with a vehicle depot. The vehicle deployment system may be communicatively coupled to a vehicle diagnostics system, and the at least one vehicle deployment system processor may base the determination of when a replacement vehicle is required for a specific vehicle that requires repair or maintenance at least in part on vehicle diagnostic analysis information received from the vehicle diagnostics system. The vehicle deployment system may be communicatively coupled to a parts logistics system, and the at least one vehicle deployment system processor may base the determination of when a replacement vehicle is required for a specific vehicle that requires repair or maintenance at least in part on vehicle parts logistics information received from the parts logistics system. The vehicle deployment system may be communicatively coupled to a vehicle diagnostics system and a parts logistics system, and the at least one vehicle deployment system processor may base the determination of when a replacement vehicle is required for a specific vehicle that requires repair or maintenance at least in part on vehicle diagnostic analysis information received from the vehicle diagnostics system and at least in part on vehicle parts logistics information received from the parts logistics system. The at least one authoring system processor may publish a new version of vehicle related authored content for approval by a plurality of entities, store approvals received from the entities to the at least one authoring system nontransitory processor-readable medium, identify any of the entities from which approval is pending, and cause the authoring system communications subsystem to provide notifications regarding any of the approvals which are pending. The at least one authoring system processor may cause the authoring system communications subsystem to provide notifications regarding any of the approvals which are pending to any of the entities form which approval is pending. The at least one authoring system processor may cause the authoring system communications subsystem to provide notifications regarding any of the approvals which are pending to at least one supervisory entity. The at least one authoring system processor may provide notification to the authored content distribution system in response to obtaining the approvals from a defined set of the entities. The at least one authoring system processor may provide the new version of the vehicle related authored content to the authored content distribution system in response to obtaining the approvals from a defined set of the entities.

A method of facilitating operation of vehicles may be summarized as including generating by an authoring system a number of versions of vehicle related authored content; at least temporarily storing in a nontransitory storage medium communicably coupled to the authoring system the number of versions of vehicle related authored content at least until each version of the vehicle related authored content is approved by at least one approval authority; providing by an authored content distribution system communicably coupled to the authoring system, networked communications at least with a plurality of end user devices; tracking by the authored content distribution system an approval by the least one approval authority of at least one of the number of versions of the vehicle related authored content; and distributing the approved versions of the vehicle related authored content to each of the plurality of end user devices.

The method may further include receiving vehicle related authored content distributed by the authored content distribution system by each of at least some of the plurality of end user devices; and providing the vehicle related authored content on each of the at least some of the plurality of end user devices via a user interface on each of at least some of the plurality of end user devices. Receiving vehicle related authored content distributed by the authored content distribution system by each of at least some of the plurality of end user devices may include receiving vehicle related authored content distributed by the authored content distribution system by each of a tablet computer device and a head unit of a vehicle. Distributing the approved versions of the vehicle related authored content to each of the plurality of end user devices may include distributing an approved version of at least one checklist which is specific to a make and model of a vehicle. Distributing the approved versions of the vehicle related authored content to each of the plurality of end user devices may include distributing an approved version of at least one vehicle operation manual. Distributing the approved versions of the vehicle related authored content to each of the plurality of end user devices may include distributing an approved version of at least one vehicle service manual. Distributing the approved versions of the vehicle related authored content to each of the plurality of end user devices may include distributing at least one of: an approved version of a textual description, an approved version of a diagram, an approved version of an illustration, an approved version of a picture, an approved version of animated sequence, or an approved version of a video. The method may further include providing by a compliance audit system communicably coupled to the authored content distribution system, networked communications at least with a plurality of end user devices; collecting by the compliance audit system data indicative of a successful synchronization between the authored content distribution system and each of the plurality of end user devices; and communicating by the compliance audit system the collected data indicative of a synchronization status associated with each of the plurality of end user devices. Collecting by the compliance audit system data indicative of a successful synchronization between the authored content distribution system and each of the plurality of end user devices may include determining whether each of the plurality of end user devices has synchronized with the authored content distribution system using a defined date. Collecting by the compliance audit system data indicative of a successful synchronization between the authored content distribution system and each of the plurality of end user devices may include determining whether each of the plurality of end user devices has synchronized with the authored content distribution system using a defined period of time. Collecting by the compliance audit system data indicative of a successful synchronization between the authored content distribution system and each of the plurality of end user devices may include determining whether each of the plurality of end user devices has synchronized with the authored content distribution system subsequent to a date associated with a latest approved version of the vehicle related authored content. The method may further include determining by the compliance audit system whether data indicative of a most current, approved, version of the vehicle related authored content is stored in each of the plurality of end user devices. Communicating by the compliance audit system the collected data indicative of a synchronization status associated with each of the plurality of end user devices may include transmitting by the compliance audit system a notification to each of the plurality of end user devices that have not synchronized with the authored content distribution system within a defined time or by a defined date. Communicating by the compliance audit system the collected data indicative of a synchronization status associated with each of the plurality of end user devices may include transmitting by the compliance audit system a notification to a logical address associated with a supervisor, the notification including data indicative of each of the plurality of end user devices that has not synchronized within a defined time or by a defined date. Communicating by the compliance audit system the collected data indicative of a synchronization status associated with each of the plurality of end user devices may include generating by the compliance audit system a compliance report that includes data indicative each of the plurality of end user devices that have not synchronized within a defined time or by a defined date; and transmitting by the compliance audit system a notification to a logical address associated with a supervisor, the notification including data representative of the generated compliance report. The method may further include receiving data representative of vehicle system information for at least one vehicle by a vehicle diagnostics system operably coupled to at least one vehicle and communicably coupled to at least one of the plurality of end user devices; analyzing the received data representative of vehicle system information by the at least one vehicle diagnostics system; based at least in part on the analyzed data representative of vehicle system information, generating by the vehicle diagnostics system an analytical result; and providing the analytical result to at least one of the plurality of end user devices. The method may further include receiving user entered data representative of vehicle system information for a specific vehicle by a vehicle diagnostics system communicably coupled to at least one of the plurality of end user devices; analyzing the received data representative of vehicle system information for the specific vehicle by the at least one vehicle diagnostics system; based at least in part on the analyzed data representative of vehicle system information for the specific vehicle, generating by the vehicle diagnostics system an analytical result for the specific vehicle; and providing the analytical result for the specific vehicle to at least one of the plurality of end user devices in the form of at least one tutorial indicative of an operation to be performed on the specific vehicle. The method may further include receiving data representative of vehicle system information automatically collected from a specific vehicle by a vehicle diagnostics system operably coupled to the specific vehicle and communicably coupled to at least one of the plurality of end user devices; analyzing the received data representative of vehicle system information for the specific vehicle by the at least one vehicle diagnostics system; based at least in part on the analyzed data representative of vehicle system information for the specific vehicle, generating by the vehicle diagnostics system an analytical result for the specific vehicle; and providing the analytical result for the specific vehicle to at least one of the plurality of end user devices in the form of authored content including information indicative of an operation to be performed on the specific vehicle or a piece of executable authored content for execution by at least one processor operably coupled to the specific vehicle. Providing the analytical result for the specific vehicle to at least one of the plurality of end user devices in the form of authored content may include determining by the vehicle diagnostics system a role associated with an end user logically associated with the end user device logically associated with the specific vehicle; selecting by the vehicle diagnostics system authored content to be provided based at least in part on the determined role of the end user logically associated with the end user device logically associated with the specific vehicle. The method may further include storing location information for a plurality of vehicle parts in a nontransitory medium associated with a parts logistics system; receiving by the parts logistics system the analytical result for a specific vehicle from the vehicle diagnostics system; based at least part on the analytical result received from the vehicle diagnostics system, determining by the parts logistics system a number of parts needed for maintenance or repair of a specific vehicle; specifying by the parts logistics system data indicative of at least one of a location or date associated with the parts that are needed for the maintenance or the repair of the specific vehicle. Specifying by the parts logistics system data indicative of at least one of a location or date associated with the parts that are needed for the maintenance or the repair of the specific vehicle may include generating by the parts logistics system a request for the parts required for maintenance or repair of the specific vehicle; and transmitting by the parts logistics system the generated request for parts to a distribution facility, to a repair facility or to a field location of the specific vehicle. Specifying by the parts logistics system data indicative of at least one of a location or date associated with the parts that are needed for the maintenance or the repair of the specific vehicle may include specifying by the parts logistics system data indicative of a specific location in a distribution facility or a repair facility for materials required for maintenance or repair of the specific vehicle. Specifying by the parts logistics system data indicative of at least one of a location or date associated with the parts that are needed for the maintenance or the repair of the specific vehicle may include specifying by the parts logistics system data indicative of a location in transit of the materials required for maintenance or repair of the specific vehicle. The method may further include storing data indicative of location information for a plurality of vehicle parts in a nontransitory storage medium communicably coupled to a parts logistics system, the parts logistics system communicably coupled to at least one of the plurality of end user devices; determining which parts are required for maintenance or repair of a specific vehicle by the parts logistics system; specifying by the parts logistics system data indicative of at least one of a location or a date associated with the parts determined as required for maintenance or repair of the specific vehicle. Specifying by the parts logistics system data indicative of at least one of a location or a date associated with the parts determined as required for maintenance or repair of the specific vehicle may include generating by the parts logistics system data representative of a request for the parts required for maintenance or repair of the specific vehicle to be sent to a distribution facility, to a repair facility or to a field service location of the specific vehicle. Specifying by the parts logistics system data indicative of at least one of a location or a date associated with the parts determined as required for maintenance or repair of the specific vehicle may include generating by the parts logistics system data representative of a specific location in a distribution facility or a repair facility of the parts required for maintenance or repair of the specific vehicle. Specifying by the parts logistics system data indicative of at least one of a location or a date associated with the parts determined as required for maintenance or repair of the specific vehicle may include generating by the parts logistics system data representative of a location in transit of the parts required for maintenance or repair of the specific vehicle. The method may further include determining by a vehicle deployment system communicably coupled to at least one of the plurality of end user devices data indicative of when a replacement vehicle is required for a specific vehicle that requires repair or maintenance; and generating by the vehicle deployment system data indicative of a request for the replacement vehicle to a management system associated with a vehicle depot. Determining by a vehicle deployment system communicably coupled to at least one of the plurality of end user devices data indicative of when a replacement vehicle is required for a specific vehicle that requires repair or maintenance may include receiving by the vehicle deployment system from a communicatively coupled vehicle diagnostics system data indicative of a vehicle diagnostic analysis for a specific vehicle that requires repair or maintenance; and determining by the vehicle deployment system whether the replacement vehicle is required based at least in part on the data indicative of the vehicle diagnostic analysis received from the vehicle diagnostics system. Determining by a vehicle deployment system communicably coupled to at least one of the plurality of end user devices data indicative of when a replacement vehicle is required for a specific vehicle that requires repair or maintenance may include receiving by the vehicle deployment system from a communicatively coupled parts logistics system data indicative of vehicle parts logistics information; and determining by the vehicle deployment system whether the replacement vehicle is required based at least in part on the data indicative of the data indicative of vehicle parts logistics information received from the parts logistics system. Determining by a vehicle deployment system communicably coupled to at least one of the plurality of end user devices data indicative of when a replacement vehicle is required for a specific vehicle that requires repair or maintenance may include receiving by the vehicle deployment system from a communicatively coupled vehicle diagnostics system data indicative of a vehicle diagnostic analysis for a specific vehicle that requires repair or maintenance; receiving by the vehicle deployment system from a communicatively coupled parts logistics system data indicative of vehicle parts logistics information; and determining by the vehicle deployment system whether the replacement vehicle is required based at least in part on the data indicative of the vehicle diagnostic analysis received from the vehicle diagnostics system and based at least in part on the data indicative of the vehicle parts logistics information received from the parts logistics system. The method may further include publishing by the authoring system processor a new version of vehicle related authored content for approval by the at least one approval authority; storing by the authoring system approvals received from the at least one approval authority to the at least one authoring system nontransitory processor-readable medium; identifying by the authoring system any approval authority from which approval is pending; generating by the authoring system data representative of a notification including data indicative of the approval authority from which approval is pending. Generating by the authoring system data representative of a notification, the notification including data indicative of the approval authority from which approval is pending may include generating by the authoring system data representative of a notification including data indicative of the approval authority from which approval is pending; and communicating the notification to the approval authority from which approval is pending. Generating by the authoring system data representative of a notification including data indicative of the approval authority from which approval is pending may include generating by the authoring system data representative of a notification including data indicative of the approval authority from which approval is pending; and communicating the notification to at least one supervisory entity. The method may further include receiving by the authoring system data indicative of an approval by the at least one approval authority from which approval is pending; and communicating by the authoring system to the authored content distribution system data indicative of a notification of the received data indicative of an approval by the at least one approval authority. The method may further include receiving by the authoring system data indicative of an approval by the at least one approval authority from which approval is pending; and providing by the authoring system to the authored content distribution the new version of the vehicle related authored content responsive to the receipt of the data indicative of the approval by the at least one approval authority from which approval is pending.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a schematic diagram of an example system for managing vehicle logistics including authored content generation, approval, and distribution, according to one non-limiting illustrated embodiment.

FIG. 2 is a block diagram of an example system for managing vehicle logistics including authored content generation, approval, and distribution, that includes a field portable electronic device communicably coupled to at least one vehicle logistics management system, according to one non-limiting illustrated embodiment.

FIG. 3 is a high-level flow diagram of a method of generating authored content including a checklist specific to a vehicle make and model and receiving data logically associated with a unique identifier assigned to a specific vehicle, according to one non-limiting illustrated embodiment.

FIG. 4 is a flow diagram of a method of generating authored content including a checklist specific to a vehicle make and model and specific to a role of a portable device user completing at least a portion of the checklist, according to one non-limiting illustrated embodiment.

FIG. 5 is a flow diagram of a method of transmitting vehicle data provided via a checklist to a remote recipient and generating a synchronization message indicative of a successful data transfer, according to one non-limiting illustrated embodiment.

FIG. 6 is a flow diagram of a method of autonomously receiving vehicle data transmitted by a vehicle by a portable computing device and populating at least a portion of a vehicle checklist using the received data, according to one non-limiting illustrated embodiment.

FIG. 7 is a flow diagram of a method of autonomously receiving vehicle data indicative of a vehicle condition by a portable computing device, according to one non-limiting illustrated embodiment.

FIG. 8 is a high-level flow diagram of a method of generating versions of authored content, tracking the approval of the versions of authored content, and distributing approved versions of the authored content, according to one non-limiting illustrated embodiment.

FIG. 9 is a flow diagram of a method of collecting compliance audit synchronization data from end user devices, according to one non-limiting illustrated embodiment.

FIG. 10 is a flow diagram of a method of receiving vehicle system data by a vehicle diagnostics system, analyzing the received data, generating an analytical result and communicating the result to an end user device, according to one non-limiting illustrated embodiment.

FIG. 11 is a flow diagram of a method of storing parts location information by a parts logistics system, determining parts needed to effect repair or maintenance of a vehicle and specifying a location or a date the parts are required for the repair or maintenance, according to one non-limiting illustrated embodiment.

FIG. 12 is a flow diagram of a method of determining a need for vehicle replacement by a vehicle deployment system, according to one non-limiting illustrated embodiment.

FIG. 13 is a flow diagram of a method of publishing a new authored content version, storing approvals associated with the new authored content version, identifying pending approvals for the new authored content version and indicating approval authorities from whom approval is pending, according to one non-limiting illustrated embodiment.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with computing devices, automotive head units, portable communication devices, manufacturing processes, document, audio, and video editing processes, the content and form of product owner's guides and maintenance manuals, and the like are not been discussed in detail.

Unless the context requires otherwise, throughout the specification and claims that follow, the word “comprise” and variations thereof, such as, “comprises” and “comprising” are to be construed in an open, inclusive sense that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment.

The use of ordinals such as first, second and third does not necessarily imply a ranked sense of order, but rather may only distinguish between multiple instances of an act or structure.

Reference to “equipment” means any mobile or stationary device or system capable of use and requiring periodic maintenance and repair. Although discussed herein in terms of a military vehicle, such should be understood to facilitate a concise description and not as limiting the following disclosure to only military vehicles.

Herein and in the claims “authored content” means any work or authorship in any form that is capable of conveying data, information or instructions. Authored content may include physical or electronic documents, hyperlinked electronic documents, images and associated image data or files, schematic illustrations or diagrams and associated data or files, animations and associated data or files, visual or video presentations and associated data or files, audio presentations and associated data or files, audiovisual presentations and associated data or files, augmented reality presentations and associated data or files, checklists, parts lists, troubleshooting procedures stored and/or presented in any format, now known or later developed. Authored content may include content in any format capable of conveying information in a manner perceivable by a human and/or by a machine or processor. Authored content may include text content, image, graphical or schematic illustration content, audio content, moving image or video content, audio/visual content, augmented reality content, machine or processor instructions, or combinations thereof. The machine or processor instructions may be in source code and/or executable (e.g., object code) form. Generally, authored content is logically associated with the use, maintenance, operation, configuration, and/or set-up of at least one component, feature, device, system, and/or sub-system included with, or which is part of, an item of manufacture (e.g., piece of equipment, vehicle). The authored content logically related to the standard and/or optional components, devices, systems, and/or sub-systems used in the assembly or construction of an item of manufacture, piece of equipment, or vehicle represent the “building blocks” from which authored content such as service guides and maintenance manuals are developed.

Herein and in the claims “Service Guide” means any printed or electronic publication that includes information relevant to the use and/or operation of one or more aspects of an item of manufacture, piece of equipment, or vehicle.

Herein and in the claims to “Maintenance Manual” means any printed and/or electronic publication that includes information relevant to the maintenance, repair, care, or upkeep of one or more aspects of an item of manufacture, piece of equipment, or vehicle.

Herein and in the claims “component” or “components” means any component, device, feature, system, or sub-system present in, or on or part of an item of manufacture, for example part of a vehicle. Components may include mechanical components, electrical components, and electromechanical components. Such components may also include features implemented either as hardware or as features implemented in hardware based at least in part on the execution of software by a dedicated processor in the vehicle or item of manufacture (e.g., a user interface on a vehicle head unit).

The headings and Abstract of the Disclosure provided herein are for convenience only and do not interpret the scope or meaning of the embodiments.

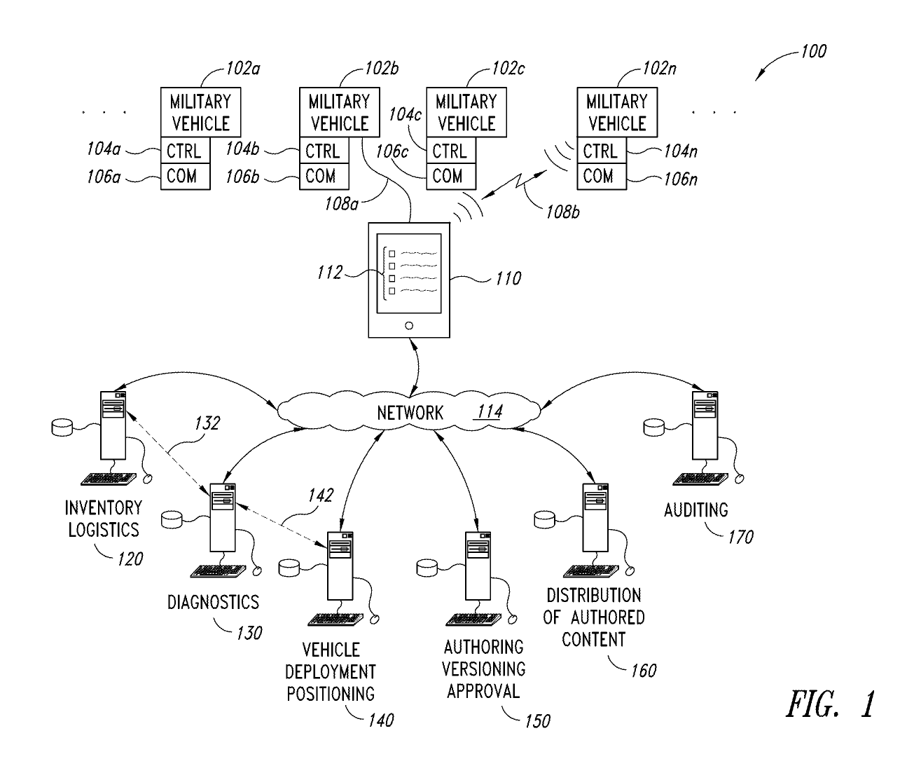

FIG. 1 shows a system 100 in which a number of military vehicles 102a-102n (collectively “vehicles 102”) are communicably coupled to a number of systems via an intervening portable electronic device 110 and network 114. A vehicle 102 requires preventive maintenance and ongoing maintenance to repair damage and normal wear items. Military vehicles 102 may require additional or specialized service or maintenance based at least in part on the hostile or adversarial operating environments or conditions to which such vehicles are typically subjected. Given the potentially large number of vehicles 102 used in fleet service (e.g., commercial tucking) or in military service, tracking the maintenance for a specific vehicle based on service conditions, prior repairs, operating wear and damage, scheduled or preventive maintenance requires a significant human and capital investment in logistical infrastructure. Where some or all of such vehicles are used in geographically diverse field environments, such ongoing preventive and restorative maintenance requires large scale (i.e., global) logistical planning, resource allocation, and resource management.

One or more digital processors or controllers 104 control some or all of the mechanical or electrical systems found in many private, commercial, and military vehicles 102. For example, vehicle engines often have one or more controllers 104 to adjust motor operating parameters to improve fuel efficiency, reduce emissions, or alternate between powertrain systems (e.g., switch between internal combustion and hybrid powertrain systems). Vehicle powertrains may have a number of controllers 104 to implement antilock braking, operate traction control, switch between drivetrain systems (e.g., switch between two wheel and four wheel drive systems). Instrumentation, climate control, and communications systems may share of have dedicated controllers 104. In operation, each controller 104 receives signals from sensors and similar data acquisition or data collection devices or systems coupled to one or more vehicular systems. Based on the received data, each controller 104 is able to operate, control, alter or adjust one or more vehicular system operating parameters as well as determine when one or more systems may be in need of maintenance or repair. For example, a “CHECK ENGINE” light (or similar indicator) may indicate the need for service or repair to the vehicle engine or one or more engine support systems (e.g., fuel, air, emissions control, ignition) to the vehicle operator. At times, a diagnostic or service code generated by one or more controllers 104 may accompany such an indicator. These diagnostic or service codes provide vehicle crewmembers or maintenance personnel with an indication of the type of service, repair, and/or maintenance procedure required to restore the vehicle to a desired operating condition. On the other hand, military and commercial vehicles may be equipped with one or more busses (e.g., a controller area network or “CAN” bus) to facilitate the communication of such maintenance, repair or diagnostic signals between onboard controllers or between the controllers and one or more remote devices. The ability to transmit service information from each vehicle advantageously permits the coordination of maintenance via one or more centralized systems.

In at least some instances, each vehicle 102 may be equipped with one or more communications interfaces 106a-106n (collectively “communications interfaces 106”) to facilitate communication between the vehicle 102 and one or more external devices 110. For example, the communications interface 106 may communicably couple a vehicle to an external device 110 via a tethered connection 108a, a wireless connection 108b, or some combination thereof (collectively “connection 108”). Such data may include, without limitation, data provided autonomously by a vehicular controller, data provided by autonomously by a vehicular sensor, data provided manually by a vehicle operator or crewmember, or any combination thereof. In at least some instances, the communications interface 106 may be communicably coupled to at least one or more vehicular busses (e.g., the CAN bus). In some instances, (not shown in FIG. 1) one or more intervening networks may transport signals between some or all of the vehicles 102 and the external device 110.

The portable device 110 can include any device capable of communicably coupling to one or more vehicles 102 via one or more connections 108. Example external devices can include, but are not limited to: portable computing devices such as tablet and laptop computers; handheld computing devices such as personal digital assistants and smartphones; and wearable computing devices such as Google® Glass® which may provide authored content in a form of virtual or augmented reality presentations.

In at least some instances, the portable device 110 may include a vehicle operation tablet computer. The vehicle operation tablet computer may be assigned to a vehicle crewmember staffing the vehicle or to a dedicated vehicle maintenance technician. In some instances, the vehicle operation tablet computer provides checklists and/or instruction sets 112 to the system user based at least in part on the primary role assigned to or associated with the system user. For example, the vehicle checklists and/or instruction sets 112 provided by the vehicle operation tablet computer to an identified maintenance technician may have greater technical content or technical scope than the vehicle checklists and/or instruction sets 112 provided to an unidentified user or a user identified by the vehicle operation tablet computer as a vehicle crewmember having a different primary assignment. In another example, the vehicle checklists and/or instruction sets 112 provided to a maintenance technician qualified at a higher level of technical training or education (e.g., a certified level 4 vehicle maintenance specialist) may contain instructions or procedures not included in the vehicle checklists and/or instruction sets 112 provided to an unqualified maintenance technician or a maintenance technician qualified at a lower level of technical training or education (e.g., a certified level 1 mechanic).

The vehicle operation tablet computer assigned to a group or unit operating a limited number of different vehicle makes and/or models may contain stored, saved, or otherwise retained checklists and/or instruction sets 112 relevant to only those vehicle makes and models associated with or assigned to the unit. Thus, a logical association may exist between the vehicle operation tablet computer and a limited number of vehicle makes and models. For example, a vehicle operation tablet computer assigned to a unit equipped principally with wheeled vehicles may not include checklists and/or instruction sets 112 associated with the maintenance and repair of tracked vehicles.

Data communicated by the vehicle 102 to the external device 110 is communicated in whole or in part with one or more back-end systems communicably coupled to the external device 110 via the network 114. Such back-end systems may include, but are not limited to: one or more inventory logistics systems 120, one or more diagnostics systems 130, one or more vehicle deployment or positioning systems 140, one or more authored content versioning approval systems 150, one or more authored content distribution systems 160, and/or one or more auditing systems 170. Each of these systems is described in detail below.

The inventory logistics system 120 can provide supply chain management for the parts and materials used to repair and maintain the vehicles 102. Maximizing the operational availability of vehicles 102 typically entails delivery of parts and materials used in the operation and maintenance of vehicles 102 to appropriate locations and at appropriate times when each particular vehicle is available for maintenance and repair. The inventory logistics system 120 coordinates the flow of parts and materials from the supplier to one or more warehouse, depot, or distribution points for storage and forwarding to one or more field, repair, and/or maintenance locations. The inventory logistics system 120 further coordinates the delivery of parts and materials used in maintaining and repairing particular vehicles in a field location or service depot location where a particular vehicle is positioned and at a time when the particular vehicle is available for maintenance or repair. The inventory and logistics system 120 can further coordinate the expedited delivery of parts and materials used in the repair of vehicles suffering damage in the field. In at least some instances, the inventory logistics system 120 may be included in an enterprise management system that includes at least accounting functionality (e.g., order placement, order tracking, accounts receivable/payable functionality). In at least some instances, the inventory logistics system 120 may be included in a transportation management system that includes sea, air, and land routing and/or logistics for distribution and delivery of parts and materials used in the maintenance and repair of vehicles 102.

In at least some instances, the inventory logistics system 120 may include one or more modules or subsystems that predict the type and number of parts and/or materials used at a particular location or to maintain or repair a particular vehicle type based at least in part on the operating environment in which the vehicle is deployed. Such modules or subsystems advantageously facilitate the use of “just in time” or similar delivery schemes that minimize parts and/or maintenance item inventory carrying costs at warehouse, depot, or distribution locations.

The diagnostics system 130 provides vehicle maintenance or repair analysis capabilities exceeding those onboard the portable device 110. The portable device 110 can include limited diagnostic capabilities that provide the ability to maintain or service the vehicle 102 in the field. In some instances, the repair and/or maintenance required by a vehicle 102 may involve comprehensive maintenance or repair procedures that are not included in the more routine maintenance procedures onboard the portable device 110. For example, the portable device 110 may provide a maintenance technician or vehicle crewmember a daily checklist of inspection items particular to a vehicle make and model. Such checklists may be temporally generated (e.g., daily, weekly, bi-weekly, and monthly checklists) or event driven checklists generated responsive to one or more detected vehicle conditions (e.g., a checklist that includes inspecting the vehicle drivetrain generated by the portable device 110 responsive to a detected high bearing temperature in the drivetrain). In at least some instances, the diagnostic system 130 uses the information provided via a checklist or similar user interface on the portable device 110 to analyze one or more aspects of a particular vehicle 102. Based on the results of the analysis performed by the diagnostics system 130, information regarding one or more maintenance and/or repair procedures is communicated to the portable device 110. In some instances, such as when a vehicle 102 is in a remote location removed from parts and material resources to complete the repair or maintenance procedure, such repair or maintenance information may take the form of expedient repairs or maintenance sufficient to permit the movement of the vehicle to a more fully equipped repair or maintenance facility.

In at least some instances, the diagnostics system 130 and the inventory logistics system 120 are communicably coupled 132. In such instances, the diagnostic system 130 may determine one or more parts and/or materials needed to perform a repair or maintenance procedure on a particular vehicle are not available at the vehicle's location or will not be available when the vehicle reaches the repair location. In such instances, by communicating data indicative of the parts and/or materials needed for the repair and/or maintenance procedure and the estimated time of arrival of the vehicle at the repair location to the inventory logistics system 120, the inventory logistics system 120 can acquire and route the parts and/or materials to the future vehicle repair location. Such integration can advantageously expedite the repair or maintenance process and reduce the vehicle downtime associated with performing the repairs or maintenance.

The vehicle deployment and positioning system 140 provides motor pool logistical information to the portable device 110. In some instances, the diagnostic system 130 may determine based on economic considerations, temporal considerations, or both, to deploy a replacement vehicle in lieu of repairing a damaged vehicle. In such instances, the vehicle deployment and positioning system 140 can provide information to the portable device regarding the availability, location, and estimated time of availability of the replacement vehicle. Large organizations, such as commercial fleet operators and military organizations frequently maintain a ready reserve of vehicles to replace those vehicles damaged, destroyed, or otherwise rendered unfit for service. Typically, such replacement vehicles are stored in one or more central storage locations, depots, warehouses, motor pools or the like. As replacements are needed in the field, vehicles are pulled from the central storage location and routed to a field location. The vehicle deployment and positioning system 140 provides data indicative of the type, number, and location of an organization's reserve supply of vehicles.

In at least some instances, the vehicle deployment and positioning system 140 and the diagnostics system 130 are communicably coupled 142. In such instances, the diagnostic system 130 may determine that the repairs or maintenance required by a particular field vehicle is too extensive and a replacement vehicle is preferable. In such instances, the diagnostics system may provide vehicle make, model, and/or type information to the vehicle deployment and positioning system 140. Responsive to the receipt of the information indicative of a vehicle make, model, and/or type, the vehicle deployment and positioning system 140 can dispatch a replacement vehicle from a motor pool or supply depot. In some instances, the inventory logistics system 120 can route the replacement vehicle provided by the vehicle deployment and positioning system 140 to the appropriate field location.

Within large fleet operations, standardized maintenance practices and procedures streamline servicing, ensure all vehicles receive in near uniform maintenance, and increase the operational availability of all vehicles within the fleet. Such standardized maintenance practices and procedures often originate with information provided by the vehicle manufacturer and/or equipment supplier. Standardized maintenance may include a variety of checklists tailored to routine or preventive maintenance performed in the field by a vehicle crewmember or at a service location by a maintenance technician. Standardized maintenance may also include checklists or instructions on repairing or restoring expected vehicle damage typically encountered during field operations (e.g., replacing a flat tire, swapping a radio, replacing a windshield).

Fleet operators create such maintenance and repair checklists and instructions based on manufacturer requirements, recommendations, and best practices. Maintenance and repair checklists and instructions are generally vehicle make and model specific. Maintenance and repair checklists used by a fleet operator are also tailored to the vehicles and are reflective of the expected operating conditions encountered by the vehicles. Thus, in addition to manufacturer or supplier based practices and procedures, such checklists are often customized by the fleet operator to reflect the operational experience of the fleet operator with a particular vehicle make and model and also based upon the expected service conditions that the vehicle will encounter.

Fleet operators will consider vehicle manufacturer and/or equipment supplier maintenance and repair requirements, recommendations, and best practices as a baseline in preparing maintenance and repair checklists and instructions. In addition to the requirements, recommendations, and best practices provided by the vehicle manufacturer and/or equipment supplier, the fleet operator can modify existing instructions or checklist items or provide additional instructions or checklist items based on operational experience and expected vehicle service conditions.

Many large organizations distribute checklists and instructions to maintenance and service personnel only after one or more levels of organizational review and approval. The review and approval process may include one or more divisional approvals to ensure adequate staffing, training, supplies, and materials are available to support the expected maintenance and repair needs of the vehicle fleet. For example, the personnel department may review checklists and instructions to ensure adequate staffing exists, to ensure staff training is adequate, and to coordinate additional training to support the maintenance and repair practices and procedures. A supply chain department may review checklists and instructions to ensure supplies needed to perform various maintenance and repair processes are at levels in in locations necessary to support fleet operations. Each of a number of organizational levels, groups, and/or departments approves or otherwise certifies the accuracy and/or content of each checklist and/or set of instructions prior to widespread distribution throughout the organization. Changes, alterations, additions, and/or revisions also pass through a similar approval process to ensure the organization maintains adequate human and material resources to facilitate fleet operations. Given the diversity of vehicles operated by an organization and the potentially large number of vehicles in the organization, developing checklists and instruction sets and tracking the various prerequisite approvals of each of the checklists and instruction sets presents a significant logistical hurdle.

In at least some instances, checklists and/or instruction sets may be developed in electronic format, for example using one or more asset authoring and distribution systems as described in U.S. Patent Application Ser. No. 61/861,887, filed Aug. 2, 2013 and U.S. Patent Application Ser. No. 61/865,463 filed Aug. 13, 2013, each of which are incorporated herein by reference in their entireties. Electronic checklists and/or instruction sets may be provided by the vehicle manufacturer and/or equipment supplier or may be generated by the fleet operator. As organizationally unapproved documents, such checklists and/or instruction sets must be reviewed and approved prior to distribution.

The Authoring Versioning Approval System 150 provides a system for tracking and providing notifications of pending and granted approvals for electronic documents such as checklists and instruction sets within an organization. In some instances, the Authoring Versioning Approval System 150 may include one or more optional components such as a document scanner or similar to facilitate the generation of electronic checklists and/or instruction sets from paper or similarly published documents. In other instances, the Authoring Versioning Approval System 150 may receive one or more electronic files containing data representative of one or more checklists and/or instruction sets 112. The fleet operator, the vehicle manufacturer, the equipment supplier or any combination thereof may generate the checklists and/or instruction sets 112 in whole or in part.

The Authoring Versioning Approval System 150 can route the received checklists and/or instruction sets 112 to the appropriate approval authorities within the fleet operator's organization. In some instances, such routing may include the generation and transmission of email or similar notifications that announce the availability of the checklists and/or instruction sets 112 for review and approval. In some instances, the Authoring Versioning Approval System 150 may establish due dates for review and approval and may follow up with periodic reminders of pending, unapproved, checklists and/or instruction sets 112. In some instances, the Authoring Versioning Approval System 150 may store or otherwise retain approved checklists and/or instruction sets 112 in a communicably coupled nontransitory storage to provide an evolutionary history for each checklist and/or instruction set 112.

After receiving organizational approval, the Authoring Versioning Approval System 150 communicates or otherwise transmits each checklist and/or instruction set 112 to the Authored Content Distribution System 160. The Authored Content Distribution System 160 distributes the approved checklists and/or instruction sets 112 to the appropriate recipients throughout the organization. In some instances, the Authored Content Distribution System 160 distributes checklists and/or instruction sets 112 specific to a particular vehicle make and model to the portions of the organization operating, maintaining and repairing those vehicles. The Authored Content Distribution System 160 may not routinely transmit checklists and/or instruction sets 112 not relevant to a particular group within an organization to the group however such checklists and/or instruction sets 112 may be distributed by the Authored Content Distribution System 160 to the portable device 110 upon request.

In addition to transmitting various checklists and/or instruction sets 112 throughout the organization, the Authored Content Distribution System 160 also tracks the version of the checklists and/or instruction sets 112 used by various groups within the organization to ensure the appropriate checklists and/or instruction sets 112 is in use. For example, a first group within the organization may be equipped with FV432 Mark I armored personnel carriers while a second group within the organization may be equipped with a number of later developed FV432 Mark III armored personnel carriers. The Authored Content Distribution System 160 can ensure the first group receives, loads, and uses the latest version of checklists and/or instruction sets 112 relevant to the FV432 Mark I, and the second group receives, loads and uses the latest version of checklists and/or instructions sets 112 relevant to the FV432 Mark III. The Authored Content Distribution System 160 also ensures the first and the second groups receive, load, and use checklists and/or instruction sets 112 relevant to both Mark I vehicles and Mark III vehicles.

The Auditing System 170 can audit field devices, including portable devices 110, to ensure the latest checklists and/or instruction sets 112 versions are in use by operating, maintenance, and repair personnel. Operational requirements, particularly for military organizations, may dictate that the portable devices 110 used by vehicle crews to perform checklist reviews and to plan, schedule, and/or perform vehicle field maintenance or repairs remain in a “dark mode” in which communications are disabled for operational security purposes. Since the Authored Content Distribution System 160 can distribute revised checklists and/or instruction sets 112 at any time, the possibility exists that at least some checklists and/or instruction sets 112 will be issued when the portable devices 110 are in dark mode. In other instances, vehicles may be operating in remote areas (e.g., an oilfield environment in remote northern Canada) having no or unreliable communications and one or more checklist and/or instruction set 112 updates may be missed or only partially received by the portable device 110. In such instances, the Auditing System 170 will confirm the latest versions of any checklists and/or instruction sets 112 relevant to the vehicles associated with a particular portable device 110 are loaded when the portable device 110 establishes a communicable coupling to the network 114.

In at least some implementations, the above-described functionality of the Inventory Logistics System 120, Diagnostics System 130, Vehicle Deployment and Positioning System 140, Authoring Versioning Approval System 150, Authored Content Distribution System 160, and Auditing System 170 may be combined as modules or the functional equivalent thereof into one or more systems such as an Enterprise Management system. While not explicity illustrated as such, the network 114, or some other network, may provide access to computer systems of one or more original equipment manufacturers (OEMs), for instance a manufacturer of the vehicle. Such may, for example, take the form of an OEM/MOD Web portal, which provides access to manufacturer related information such as system design documents, manuals, charts, diagnostic procedures, parts lists, etc. Such may provide access to authored content, which may or may not be proprietary content.

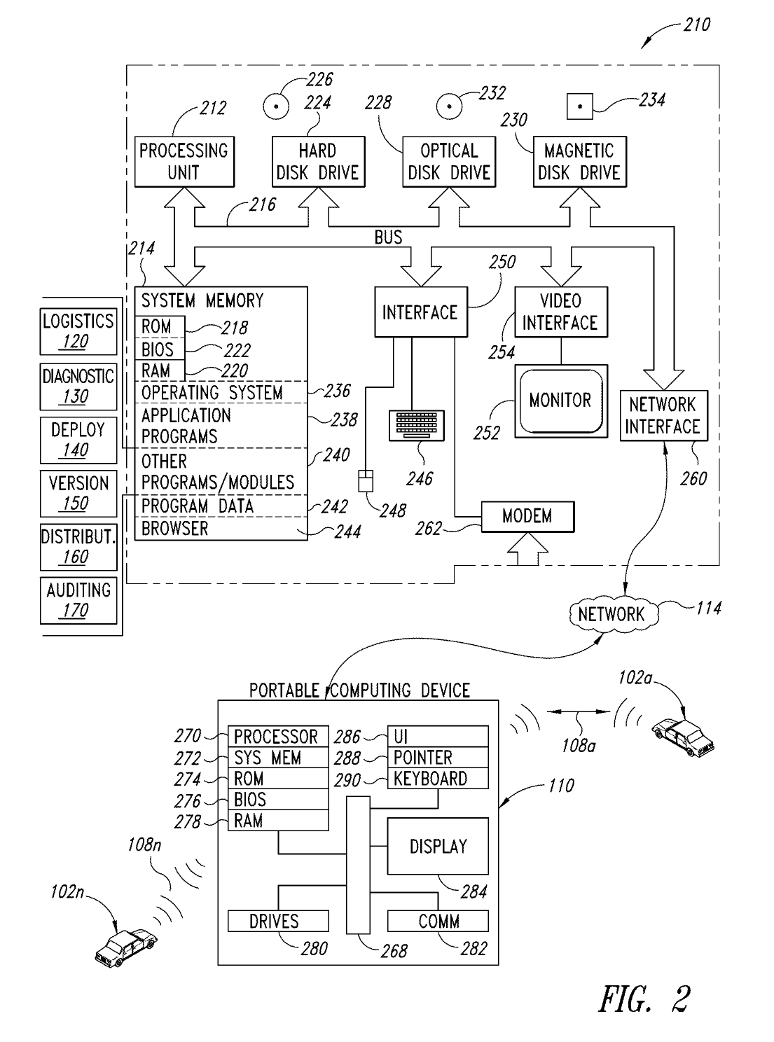

FIG. 2 and the following discussion provide a brief, general description of an example suitable computing environment that includes a back office system 210 incorporating an Inventory Logistics System 120, a Diagnostics System 130, a Vehicle Deployment and Positioning System 140, an Authoring Versioning Approval System 150, an Authored Content Distribution System 160, and an Auditing System 170. The network 114 communicably couples the back-end system 210 to a portable device 110.

Although not required, the embodiments will be described in the general context of computer-executable instructions, such as program application modules, objects, or macros being executed by a computer. Those skilled in the relevant art will appreciate that the illustrated embodiments as well as other embodiments can be practiced with other computer system configurations, including hand-held devices, multiprocessor systems, microprocessor-based or programmable consumer electronics, personal computers (“PCs”), network PCs, mini computers, mainframe computers, and the like. The embodiments can be practiced in distributed computing environments where tasks or modules are performed by remote processing devices, which are linked through a communications network. In a distributed computing environment, program modules may be located in both local and remote memory storage devices.

The back-end system 210 may take the form of a conventional mainframe or mini-computer that includes a processing unit 212, an at least partially nontransitory system memory 214 and a system bus 216 that couples various system components including the system memory 214 to the processing unit 212. The back-end system 210 will at times be referred to in the singular herein, but this is not intended to limit the embodiments to a single back-end system since in typical embodiments, there will be more than one back-end system or other device involved. The computing environment may employ other computers, such as conventional personal computers, where the size or scale of the system allows.

The processing unit 212 may be any logic processing unit, such as one or more central processing units (CPUs), digital signal processors (DSPs), application-specific integrated circuits (ASICs), etc. Unless described otherwise, the construction and operation of the various blocks shown in FIG. 2 are of conventional design. As a result, such blocks need not be described in further detail herein, as they will be understood by those skilled in the relevant art.

The system bus 216 can employ any known bus structures or architectures, including a memory bus with memory controller, a peripheral bus, and a local bus. The system memory 214 includes read-only memory (“ROM”) 218 and random access memory (“RAM”) 220. A basic input/output system (“BIOS”) 222, which can form part of the ROM 218, contains basic routines that help transfer information between elements within the back-end system 210, such as during start-up.

The back-end system 210 also includes a hard disk drive 224 for reading from and writing to a hard disk 226, and an optical disk drive 228 and a magnetic disk drive 230 for reading from and writing to removable optical disks 232 and magnetic disks 234, respectively. The optical disk 232 can be a CD-ROM, while the magnetic disk 234 can be a magnetic floppy disk or diskette. The hard disk drive 224, optical disk drive 228 and magnetic disk drive 230 communicate with the processing unit 212 via the system bus 216. The hard disk drive 224, optical disk drive 428 and magnetic disk drive 430 may include interfaces or controllers (not shown) coupled between such drives and the system bus 216, as is known by those skilled in the relevant art. The drives 224, 228 and 230, and their associated computer-readable media 226, 232, 234, provide nonvolatile storage of computer readable instructions, data structures, program modules and other data for the back-end system 210. Although the depicted back-end system 210 employs hard disk 224, optical disk 228, and magnetic disk 230, those skilled in the relevant art will appreciate that other types of computer-readable media that can store data accessible by a computer may be employed, such as magnetic cassettes, flash memory cards, digital video disks (“DVD”), Bernoulli cartridges, RAMs, ROMs, smart cards, solid state drives, etc.

Program modules can be stored in the system memory 214, such as an operating system 236, one or more application programs 238, other programs or modules 240 and program data 242. The system memory 214 may also include communications programs for example a Web client or browser 244 for permitting the back-end system 210 to access and exchange data with sources such as Web sites of the Internet, corporate intranets, or other networks as described below, as well as other server applications on server computing systems such as those discussed further below. The browser 244 in the depicted embodiment is markup language based, such as Hypertext Markup Language (HTML), Extensible Markup Language (XML) or Wireless Markup Language (WML), and operates with markup languages that use syntactically delimited characters added to the data of a document to represent the structure of the document. A number of Web clients or browsers are commercially available such as those from America Online and Microsoft of Redmond, Wash.

While shown in FIG. 2 as being stored in the system memory 214, the operating system 236, application programs 238, other programs/modules 240, program data 242 and browser 244 can be stored on the hard disk 226 of the hard disk drive 224, the optical disk 232 of the optical disk drive 228 and/or the magnetic disk 234 of the magnetic disk drive 230. A system operator can enter commands and information into the back-end system 210 through input devices such as a touch screen or keyboard 246 and/or a pointing device such as a mouse 248. Other optional input devices can include a microphone, joystick, game pad, tablet, scanner, etc. These and other input devices are communicably coupled to the processing unit 212 through an interface 250 such as a universal serial bus (“USB”) interface that couples to the system bus 216, although other interfaces such as a parallel port, a game port or a wireless interface or serial port can be used. A monitor 252 or other display device is coupled to the system bus 216 via a video interface 254, such as a video adapter. The back-end system 210 can include other output devices, such as speakers, printers, etc.

The portable device 110 may be any logic processing unit, such as one or more central processing units (CPUs), digital signal processors (DSPs), application-specific integrated circuits (ASICs), etc. Unless described otherwise, the construction and operation of the various portable device blocks shown in FIG. 2 are of conventional design. As a result, such blocks need not be described in further detail herein, as they will be understood by those skilled in the relevant art.

The system bus 268 can employ any known bus structures or architectures, including a memory bus with memory controller, a peripheral bus, and a local bus. The system memory 272 includes read-only memory (“ROM”) 274 and random access memory (“RAM”) 278. A basic input/output system (“BIOS”) 276, which can form part of the ROM 274, contains basic routines that help transfer information between elements within the portable device 110, such as during start-up.

The portable device 110 also includes one or more storage drives 280. The one or more storage drives 280 may contain data indicative of one or more checklists and/or instruction sets 112. The storage drives 280 can include any type, number, or combination, of non-volatile, nontransitory storage media including magnetic storage media, optical storage media, electromagnetic storage media, molecular or atomic storage media, quantum storage media, or combinations thereof. The storage drive(s) 280 communicate with the processor 270 via the system bus 268. The one or more storage drives 280 may include interfaces or controllers (not shown) coupled between such drives and the system bus 268, as is known by those skilled in the relevant art. The one or more storage drives 280, provide nonvolatile storage of computer readable instructions, data structures, program modules and other data for the portable device 110.

Program modules can be stored in the system memory 272, such as an operating system, one or more application programs, other programs or modules and program data. The system memory 272 may also include communications programs for example a Web client or browser for permitting the portable device 110 to access and exchange data with sources such as Web sites of the Internet, corporate intranets, or other networks as described below, as well as other server applications on server computing systems such as those discussed further below. The browser in the depicted embodiment is markup language based, such as Hypertext Markup Language (HTML), Extensible Markup Language (XML) or Wireless Markup Language (WML), and operates with markup languages that use syntactically delimited characters added to the data of a document to represent the structure of the document. A number of Web clients or browsers are commercially available such as those from Google, Apple, America Online and Microsoft of Redmond, Wash.

The portable device 110 also includes one or more communications interfaces 282 communicably coupled to the system bus 268. The one or more communications interfaces 282 can include one or more Bluetooth® interfaces, one or more near field communications (“NFC”) interfaces, one or more cellular interfaces, or any other RF or microwave interface capable of supporting a data exchange with an external device such as a vehicle 102. The one or more communications interfaces 282 can also include one or more tethered communications interfaces such as an IEEE 1394 (“Firewire”) interface, a USB interface, or similar standard or proprietary interface capable of supporting a data exchange with an external device such as a vehicle 102. In at least some implementations, any number of communications interfaces 282 may be in simultaneous use by the portable device 110. For example, a vehicle 102 may communicate vehicle identification and system data to complete a vehicle checklist 112 appearing on the portable device 110 via a wireless IEEE 802.11 communications interface 282. At the same time, the portable device 110 may communicate the checklist information to a back-end system 210 via a global system for mobile devices (“GSM”) cellular communications interface 282.

A system operator such as a maintenance technician or vehicle crewmember can enter commands and information into the portable device 110 by providing input to a user interface 286 through input devices such as a touch screen or keyboard 290 and/or a pointing device such as a mouse 288. Other optional input devices can include a microphone, joystick, game pad, tablet, scanner, etc. These and other input devices are communicably coupled to the processor 270 through an interface such as a universal serial bus (“USB”) interface that couples to the system bus 268, although other interfaces such as a parallel port, a game port or a wireless interface or serial port can be used. A display device 284 is coupled to the system bus 268. The portable device 110 can include other optional output devices, such as speakers, printers, etc.

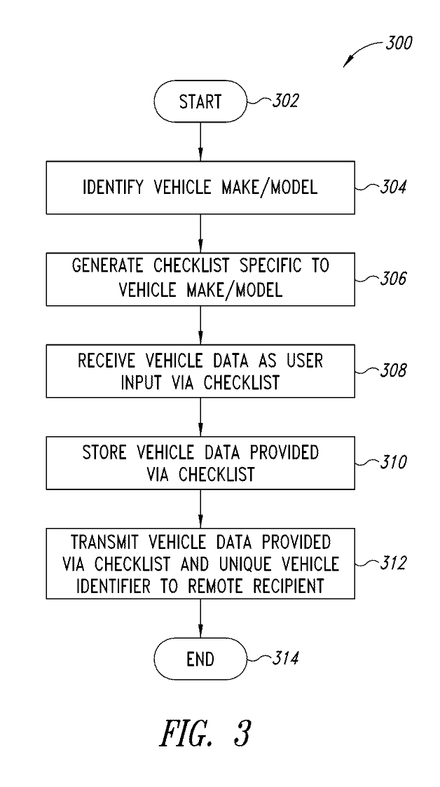

FIG. 3 is a high-level logic diagram of an example method 300 of generating a vehicle specific checklist and/or instruction set 112, storing vehicle data on the portable device 110 and transmitting the stored data to one or more remote recipients such as a back end system 210. Vehicles in field service, such as military vehicles in field service, may operate in remote and/or hostile environments having limited or no access to external maintenance or repair resources. In such instances, preventive maintenance procedures performed using on vehicle equipment and supplies assists in maintaining a high level of operational availability for the vehicle. Typically, a crewmember assigned to each vehicle is tasked with performing the routine preventive maintenance and light repairs on the vehicle. The crewmember may be tasked with other primary duties (e.g., driver, navigator, weapons systems operator) and thus have limited technical expertise related to more complex vehicular maintenance and repairs. One or more military or civilian field maintenance technicians may be assigned to provide maintenance service to a number of similar or dissimilar vehicles, for example four armored personnel carriers assigned to a mechanized infantry platoon.

The portable device 110 displays a vehicle checklist and/or instruction set 112 specific to a particular vehicle for completion either autonomously (e.g., checklist completion via data transfer from one or more vehicle onboard communications systems), manually (e.g., the crewmember or maintenance technician manually enters vehicle data into the portable device 110), or some combination thereof. The acquired or entered data received by the portable device 110 is logically associated with an identifier from the originating vehicle and stored in a nontransitory storage media for subsequent transmission to a back-end system 210. The checklist generation and data collection method commences at 302.

At 304, the portable device 110 receives data indicative of the make and model of a particular vehicle 102. In some instances, the vehicle 102 communicates information indicative of the make and model (e.g., a vehicle identification number or similar assigned defined identifier) to the portable device 110 via a tethered or wireless connection. In some instances, the crewmember or user completing the checklist on the portable device 110 enters information indicative of the make and model via a user interface 286.

At 306, responsive to the receipt of an input indicative of the vehicle make and model, the portable device 110 displays user interface including a checklist and/or instruction set 112 specific to the vehicle make and model. In some instances, the portable device 110 retrieves one or more checklists and/or instruction sets 112 from the non-transitory memory 278 and/or drives 280. In some instances, the portable device 110 retrieves one or more checklists and/or instruction sets 112 from a remote non-transitory storage location, such as from a non-transitory storage location in the backend system 210. The checklists and/or instruction sets 112 retrieved by the portable device are specific to a particular vehicle make and model. Such advantageously ensures the collection of data relevant to a particular vehicle, specifically data relevant to particular maintenance and/or repairs useful in maintaining the vehicle at a high level of operational readiness.

At 308, via the user interface 286 the crewmember or maintenance technician completes the checklist and/or instruction 112 presented on the portable device 110 display 284. In some instances, the crewmember or maintenance technician provides input to the portable device 110 via a touchscreen display. In some instances, the crewmember or maintenance technician provides input to the portable device 110 via either a physical or virtual keyboard or similar data input device 290. In some instances, the crewmember or maintenance technician provides input to the portable device 110 via any other input device, such as voice command or the like.

At 310, the data acquired by the portable device 110 is stored in a non-transitory memory. In at least some instances, such data may be stored locally in the non-transitory memory or drives 280 disposed in the portable device 110. In some instances, such data may be stored remotely in a non-transitory memory or drive coupled to one or more back end systems 210. Retaining such information in a non-volatile, non-transitory storage medium advantageously permits the development of a complete vehicle repair and maintenance history.

At 312, the portable device 110 communicates all or a portion of the acquired data stored in the non-transitory memory or drives 280 to one or more remote systems, such as one or more backend systems 210. Such data can include a vehicle identifier unique to a particular vehicle 102 and all or a portion of the data received by one or more checklists and/or instruction sets 112 logically associated with the identified vehicle 102.

In some instances, the data collected by the one or more checklists and/or instruction sets 112 is transmitted in real-time or near real-time to one or more back-end systems 210. In other instances, for example when out of communication with one or more networks or observing “radio silence” protocol, the data collected by the one or more checklists and/or instruction sets 112 is transmitted on a delayed basis to the one or more back-end systems 210, for example when communications are restored or when radio silence protocol is no longer observed. The ability to accommodate for times when a piece of equipment (e.g., a vehicle) is either out of communications, for example being outside a range of communications or operating in a “radio silence” mode is particular advantageous. In such situations, the ability to function autonomously, for instance via stored authored content allows continued operation. The ability of automatically update authored content once communications is reestablished ensures that the most up to date authored content is available, and stored in anticipation of further loss of communications. The method 300 concludes at 314.

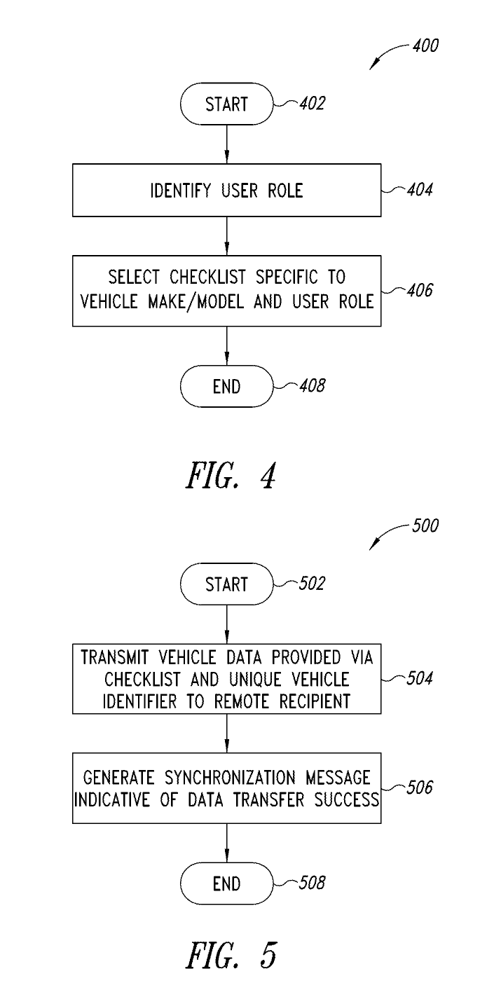

FIG. 4 is a logic diagram of an example method 400 of generating a vehicle specific checklist and/or instruction set 112 based at least in part on the identified role of the portable device user. The checklists and/or instruction sets 112 may be completed by any one of a number of personnel. For example, in some instances a crewmember or maintenance technician having some vehicle maintenance and repair training provides the data required to complete one or more vehicle checklists and/or instruction sets 112. In such instances, the portable device 110 may present the checklists and/or instruction sets 112 at a level of communication reflective of the user's technical expertise with a particular vehicle make and model. In other instances, a user may have considerable technical expertise, but little familiarity with a particular vehicle make and model. In such instances, the portable device 110 can provide the checklists and/or instruction sets 112 at a level reflective of the user's technical expertise along with supplemental materials such as audio, video, illustrations that are specific to the make and model of the vehicle based on the user's relative unfamiliarity with the particular vehicle. In yet other instances, a user having little, if any, technical training can complete all or a portion of the checklists and/or instruction sets 112 for a particular vehicle make and model. In such instances, the portable device 110 can provide the checklists and/or instruction sets 112 at a level reflective of the user's lack of technical expertise along with supplemental materials such as audio, video, illustrations that are specific to the make and model of the vehicle based on the user's lack of familiarity with the particular vehicle and lack of familiarity with the maintenance and repair procedures for the vehicle. A system providing checklists and/or instruction sets 112 at a technical level commensurate with the technical knowledge or training of the user may beneficially assist in obtaining accurate vehicle data. The method 400 of providing checklists and/or instruction sets 112 reflective of a user's role and the make and model of a particular vehicle commences at 402.

At 404, the portable device 110 identifies the role of the system user. In some instances, the system user can provide information via touchscreen or keyboard that is indicative of the user's role. In other instances, the user may cause the portable device 110 to read one or more identification media using one or more communicably coupled media readers (e.g., mag-stripe card readers, radio frequency interrogators, near field communication transceivers). In yet other instances, the portable device 110 may include one or more biometric input devices able to read one or more physiological parameters of indicative of the system user to identify the system user autonomously.

The portable device also identifies the make and model of a particular vehicle scheduled for maintenance or repairs, for example using one or more techniques discussed at 304. Based at least in part on the identified system user's role and based on the identified make and model of the particular vehicle requiring maintenance or repairs, the portable device 110 selects one or more checklists or instruction sets at 406. In some instances, the portable device 110 can provide instructional or informative supplemental information as part of the user interface 286. Such supplemental information can include illustrations, animations, audio, video, and multimedia presentations containing information commensurate with the system user's technical expertise and useful in performing the maintenance or repairs detailed in the checklists and/or instruction sets 112 presented in the user interface 286. The method of providing checklists and/or instruction sets 112 reflective of a user's role and the make and model of a particular vehicle concludes at 408.

FIG. 5 is a logic diagram of an example method 500 of transmitting data from one or more portable devices 110 to a back-end system 210 and generating a synchronization message indicative of data transfer success. As discussed above, at times vehicle data gathered by the portable device 110 may be stored in a nontransitory storage for future communication to a back-end system 210. In some instances, the data transfer from the portable device 110 to a back-end system 210 is completed as a background task by the portable device operating system. Such transfers may occur, for example, when a reliable communication channel becomes available or when a radio silence period concludes. In such instances, the system user may be unaware of the success or failure of the data transfer operation. In at least some instances, an acknowledgement of successful data synchronization between the portable device and the back-end system is provided to the system user via a message displayed on the portable device 110. The method 500 for transmitting vehicle specific data from a portable device 100 to a back end system 210 and generating a synchronization message indicative of data transfer success begins at 502.

At 504, the portable device 110 transmits acquired vehicle data and vehicle identification information to one or more remote recipients, such as the back end system 210. In some instances, the acquired vehicle data and vehicle identification information may be transmitted in real-time or near real-time to the remote recipient. In other instances, for example when a radio silence policy is in effect, the acquired vehicle data and vehicle identification information the checklist may be stored locally on the portable device 110 for subsequent transmission to the remote recipient. The data transfer from the portable device 110 to the back-end system 210 may be executed as a background task by the portable device operating system. In such instances, the system user may be unaware that the data transfer has occurred.

At 506, a synchronization message is generated on the display 284 of the portable device 110. In some instances, the back-end system 210 generates and transmits the synchronization message to the portable device 110 upon successful receipt of the acquired vehicle data and the vehicle identification information from the portable device 110. In other instances, the portable device 110 generates synchronization message upon successful completion of the transmission of acquired vehicle data and vehicle identification information to the back-end system 210. Given the at times asynchronous transmission of acquired vehicle data in vehicle identification information, the synchronization message advantageously provides the system user with an indication that data successfully transferred from the portable device 110 to the back-end system 210. The method 500 for transmitting vehicle specific data from portable device 110 to a back-end system 210 and generating a synchronization message indicative of data transfer success concludes at 508.

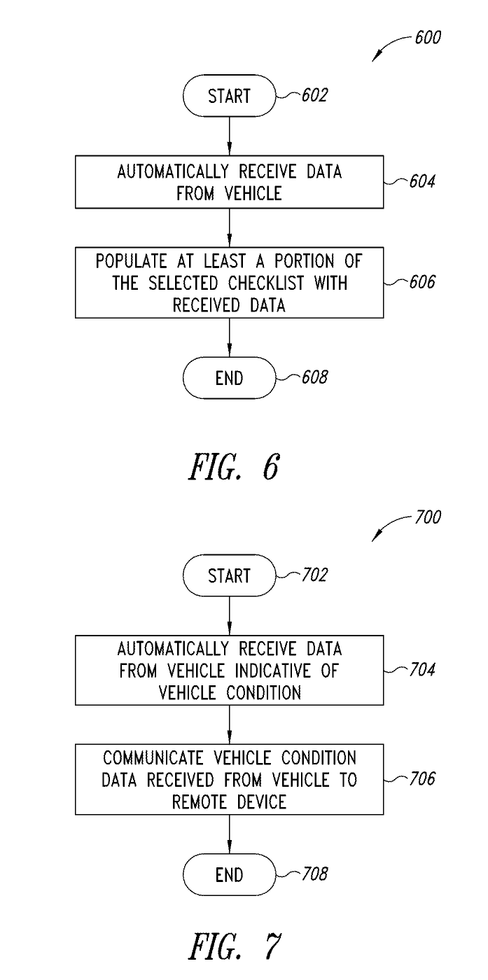

FIG. 6 is a logic diagram of an example method 600 of automatically receiving vehicle specific data from a particular vehicle and populating at least a portion of one or more checklists and/or instruction sets 112 using the received data. As discussed in detail above, sensors and controllers onboard the vehicle generate vehicle specific system data. Rather than requiring the system user to copy data retrieved from one or more vehicular systems to one or more checklist 112 on the portable device 110, at times accuracy may be improved and speed of completion enhanced by autonomously transferring data directly from the vehicle, for example via the vehicle's CAN bus, to the one or more checklists 112. The method 600 of automatically receiving vehicle specific data from the vehicle and populating one or more checklists 112 with the received data commences at 602.

At 604, one or more vehicular communications interfaces communicate information including data indicative of vehicle system data and vehicle identification information to the portable device 110. The vehicular communications interfaces may include one or more tethered interfaces, one or more wireless interfaces, or any combination thereof. In some instances, a wireless vehicular communications interface may automatically connect or communicably couple to the portable device 110. Upon connection, the portable device 110 will confirm the vehicle identification information supplied by the vehicle corresponds to the checklist 112 vehicle identification information displayed on the portable device 110. After confirming the correct vehicle, as identified using the vehicle identification information, has connected to the portable device 110 the vehicle transmits vehicle system information to the portable device 110 via the wireless communications interface.

In a similar manner, a vehicle 102 can initially communicate vehicle identification information via a tethered communications interface to a portable device 110. Upon receipt of the vehicle identification information from the vehicle, the portable device 110 will confirm the vehicle identification information supplied by the vehicle corresponds to the checklist 112 vehicle identification information. After confirming the correct vehicle as identified using the vehicle identification information, has connected to the portable device 110 the vehicle transmits vehicle system information to the portable device 110 via the tethered communications interface.

At 606, the portable device 110 populates the one or more checklists 112 with vehicle system information received by the portable device 110. The method 600 of automatically receiving vehicle specific data from the vehicle and populating one or more checklists 112 with the received data concludes at 608.

FIG. 7 is a logic diagram of an example method 700 of automatically receiving data from a vehicle indicative of the vehicle's condition and communicating the received vehicle condition data to one or more remote recipients, such as a back end system 210. Vehicles 102 in field service can suffer a variety of failures, from relatively minor field repairable failures to catastrophic failures or damage that renders the vehicle 102 unsuitable for further use. In such instances, the one or more vehicular systems generate a message containing data indicative of the vehicle condition, such as data indicative of the vehicle failure mode and/or the damage suffered by the vehicle 102. The message containing data indicative of the vehicle condition can be transmitted from the vehicular communications interface to the portable device 110 logically associated with the vehicle. The portable device 110 can transmit the message containing data indicative of the vehicle condition optionally along with additional vehicle information including vehicle identification information and/or vehicle system information to a remote recipient, such as a back-end system 210. The method 700 of automatically receiving data from a vehicle indicative of the vehicle's condition and communicating the received vehicle condition data to one or more remote recipients commences at 702.

At 704, the vehicle 102 communicates a message including data indicative of the condition of the vehicle to a portable device 110 logically associated with the vehicle 102. The vehicle condition data may include vehicle identification data, vehicle system data, and other data helpful in assessing the overall service condition and/or field reparability of the vehicle by the portable device 110 and/or a remote recipient, such as a back-end system 210. In at least some instances, the vehicle condition data transmitted from the vehicle to the portable device 110 includes vehicle system data sufficient to determine whether field repairs are possible or whether assignment of a replacement vehicle is appropriate.

At 706, the portable device 110 communicates all or a portion of the message including data indicative of the condition of the vehicle to a remote recipient, such as the back-end system 210. The method 700 of automatically receiving data from a vehicle indicative of the vehicle's condition in communicating the received vehicle condition data to one or more remote recipients concludes at 708.

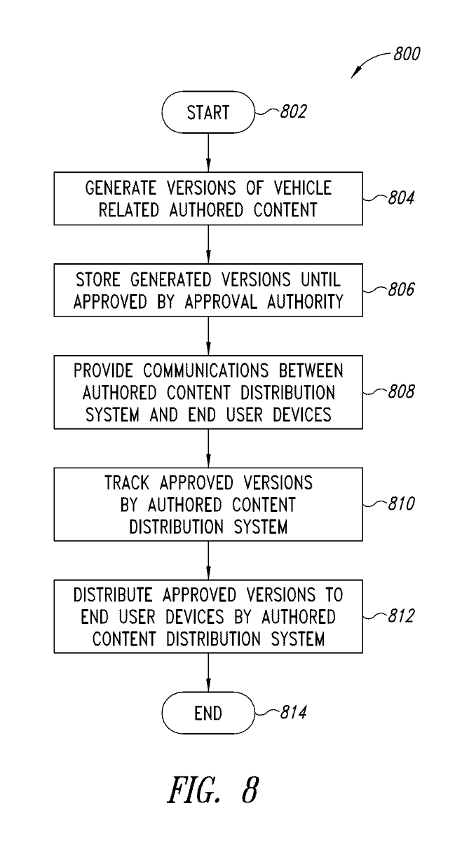

FIG. 8 is a high-level logic diagram of an example method 800 of generating versions of vehicle related authored content, storing versions until approved, communicating the versions to a number of end-user devices, and tracking the distribution of the approved versions across a number of portable devices used in vehicle fleet repair and maintenance. As discussed in detail above, vehicle related authored content includes vehicle manufacturer and/or equipment supplier repair and maintenance information made available in an electronic format that facilitates transmission to a number of portable devices 110 disposed throughout a fleet of vehicles 102. Vehicle related authored content evolves through changes, additions, and modifications to maintenance and repair checklists and instruction sets 112 that accommodate subsequent vehicle and/or vehicular system additions, modifications, and replacements that occur over time as fleet operators adapt vehicles 102 to perform in a variety of locales. Additionally vehicle manufacturers and equipment suppliers may change, modify, or alter components over time to reflect feedback based on the experiences of the fleet operator. Different versions of checklists and/or instruction sets 112 reflect the variety of vehicle systems and components placed in service by the fleet operator. Within a large organization, various groups, sections, departments, and/or individuals review and approve each of these checklists and/or instructions sets 112 prior to distribution to crewmembers and maintenance technicians. The method 800 of generating versions of vehicle related authored content and tracking the distribution of approved versions of the vehicle related authored content across any number of portable devices used for vehicle repair and/or maintenance commences at 802.

At 804, a back-end system 210 receives a number versions of vehicle related authored content. For example, an Authoring Versioning Approval System 150 forming at least a portion of the back-end system 210 can receive the number of versions of vehicle related authored content. In at least some instances, the vehicle related authored content includes one or more checklists and/or instruction sets 112. A vehicle manufacturer and/or equipment supplier may communicate or otherwise transmit the number versions of vehicle related authored content to the back-end system 210. In at least some instances, each of the number of versions of vehicle related authored content associated with a particular vehicle configuration, a particular vehicle component, a particular vehicle system, and/or a particular vehicle make and model.

At 806, the back-end system 210 stores each of the number of versions of vehicle related authored content in a non-transitory storage media. The Authoring Versioning Approval System 150 generates and communicates notifications to one or more approval authorities. Each of these notifications contains information on the vehicle related authored content requiring approval by the authority. Each of the notifications may also contain a link to the stored vehicle related authored content requiring approval or may containing a copy of the vehicle related authored content requiring approval.

At 808, after receiving all required approvals the Authoring Versioning Approval System 150 communicates the approved vehicle related authored content to the Authored Content Distribution System 160 for distribution to some or all of the portable devices 110 used by crewmembers and/or maintenance personnel to maintain and repair the vehicles 102. In some instances, the Authored Content Distribution System 160 communicates to each of the portable devices 110 the vehicle related authored content relevant to only those vehicles 102 logically associated with the portable device. Thus, for example, a portable device 110 logically associated with personnel assigned to a unit equipped with Stryker Armored Fighting Vehicles (“AFVs”) would receive checklists and/or instruction sets 112 logically associated with Stryker AFVs but would not receive checklists and/or instruction sets 112 logically associated with M1A2 Abrams main battle tanks.

At 810, the Authored Content Distribution System 160 tracks the approved versions of the vehicle related authored content received from the Authoring Versioning Approval System 150. By tracking the various approved versions of vehicle related authored content, the Authored Content Distribution System 160 confirms that the checklists and instruction sets 112 used by each portable device 110 are the most recent revisions relevant to the vehicles 102 logically associated with the portable device 110.

At 812, the Authored Content Distribution System 160 beneficially pushes the latest approved version to those portable devices 110 logically associated with the vehicle or vehicles associated with the most recent version of the vehicle related authored content. The method 800 of generating versions of vehicle related authored content and tracking the distribution of approved versions of the vehicle related authored content across any number of portable devices used for vehicle repair and/or maintenance concludes at 814.

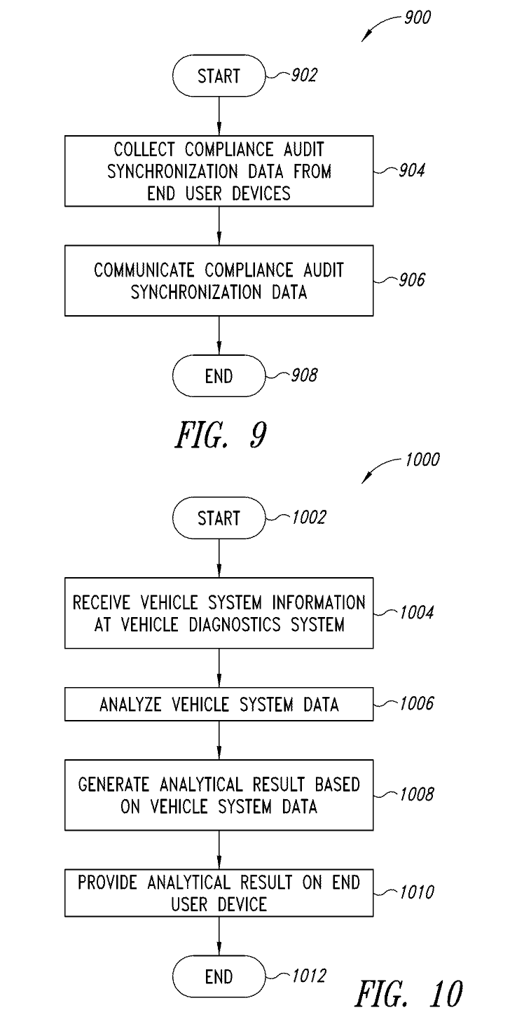

FIG. 9 is a logic diagram of an example method 900 of collecting compliance audit synchronization data from some or all portable devices 110. As discussed in detail above, portable devices 110 may operate in regions where communicable coupling to the back-end system 210 is sporadic or impossible. During operations in such areas, the portable device 110 may not receive or may only partially receive one or more updates pushed to the portable device 110 by the Authored Content Distribution System 160. In such instances, the Auditing System 170 prompts the portable device user to download one or more missed or incomplete updates.

To ensure portable device user compliance with organizational goals or requirements, the Auditing System 170 continuously or intermittently polls some or all of the portable devices 110. During the polling process, the portable device 110 communicates data indicative of the versions of vehicle related authored content stored in the portable device 110 to the Auditing System 170. The Auditing System uses the received data to determine whether the portable device 110 contains the latest versions of vehicle related authored content relevant to the vehicles logically associated with the portable device 110. The method 900 of collecting compliance audit synchronization data from some or all portable devices 110 commences at 902.

At 904, the back-end system 210 performs a compliance audit on some or all of the field deployed portable devices 110. In some instances, the Auditing System 170 performs all or a portion of the compliance auditing process. In some instances, the compliance audit collects data indicative of the vehicles logically associated with the portable device 110 and data indicative of the versions of any checklists and/or instruction sets 112 used by the portable device 110. The Auditing System 170 compares the vehicle data and the checklist and/or instruction set 112 version data to ensure the most recent revision of the checklist and/or instruction set 112 relevant to the vehicles logically associated with the portable device 110 are loaded on the portable device 110.

In some instances, the Auditing System 170 collects compliance audit data from all field deployed portable devices 110, including those portable devices 110 that have previously indicated receipt of the most recent versions of the vehicle checklists and/or instruction sets 112. In other instances, the Auditing System collects compliance audit data from only those field deployed portable devices 110 that have not indicated receipt of the most recent versions of the vehicle checklists and/or instruction sets 112.

At 906, the Auditing System 170 communicates the compliance audit synchronization data to the back-end system 210. Responsive to the receipt of the compliance audit synchronization data the back-end system 210 may cause the Authored Content Distribution System 160 to communicate the appropriate most recent revision of the vehicle related authored content to each portable device 110 that has not indicated receipt of the most recent version(s) of the vehicle checklists and/or instruction sets 112. The method 900 of collecting compliance audit synchronization data from some or all portable devices 110 concludes at 908.

FIG. 10 is a high-level logic diagram of an example method 1000 of transmitting vehicle related data collected using a portable device 110 to a back-end system 210 for analysis, and communicating data indicative of the analytical result generated by the back-end system 210 to the portable device 110. Over time, the fleet operator's back-end system 210 will collect a considerable quantity of real-world data from a number of fleet vehicles. The collected data advantageously provides a valuable resource for analyzing vehicle data in real-time or near real-time to retroactively diagnose required or recommended maintenance or repairs and also to proactively predict and/or recommend maintenance and/or repairs. The method 1000 of transmitting vehicle related data collected using a portable device 110 to a back-end system 210 for analysis, and communicating data indicative of the analytical result generated by the back-end system 210 to the portable device 110 commences at 1002.

At 1004, the back-end system 210 receives vehicle system data and vehicle identification data. In some instances, a portable device 110 assigned to a vehicle crewmember or vehicle maintenance personnel collects the data using one or more checklists and/or instruction sets 112.

At 1006, the back-end system 210 analyzes the received vehicle system data. In some instances, the Diagnostics System 130 can receive and analyze all or a portion of the vehicle system data and vehicle identification data communicated by the portable device 110.

At 1008, the back-end system 210 generates an analytical result based on the vehicle system data supplied by the portable device 110. In some instances, the Diagnostic System 130 generates the analytical result. The Diagnostic System 130 may optionally communicate to the Inventory Logistics System 120 data indicative of parts or materials needed to maintain or repair the vehicle based at least in part on the generated analytical result. Responsive to the receipt of the parts and/or materials data from the Diagnostic System 130, the Inventory Logistics System 120 acquires and delivers the needed parts and/or materials to the vehicle's location.

At 1010, the back-end system 210 communicates data indicative of the analytical result to the portable device associated with the vehicle. Such analytical result data provides the portable device user with information on required or recommended vehicle repairs and/or maintenance. In some instances, where data indicative of predicted maintenance or repairs is provided, the back-end system 210 can also provide the portable device user with an estimated duration until maintenance or repairs are due and a location where the parts and materials needed to perform the maintenance and repairs are available. The method 1000 of transmitting vehicle related data collected using a portable device 110 to a back-end system 210 for analysis, and communicating data indicative of the analytical result generated by the back-end system 210 to the portable device 110 concludes at 1012.

FIG. 11 is a logic diagram of an example method 1100 of determining the location of parts and/or materials needed for repair of one or more vehicles and specifying at least one of a date and time that the parts and/or materials are needed or a location where the parts and/or materials are needed. Within an organization parts and/or materials may be stored in any number of warehouses or depots across a geographic region or even around the world. The ability to quickly locate parts and/or materials and coordinate the transportation of the parts and/or materials to a particular location to repair and/or maintain a vehicle 102 provides a tremendous benefit and increases the operational availability of the vehicles 102. Even more beneficially, parts and/or materials may be located and transported to a future location of a particular vehicle at a point in time when maintenance and/or repairs to the vehicle 102 are predicted by the Diagnostics System 130. The method 1100 of determining the location of parts and/or materials needed for repair of one or more vehicles and specifying at least one of the date and time that the parts and/or materials are needed or a location where the parts and/or materials are needed commences at 1102.

At 1104, the back-end system 210 receives data indicative of an identifier associated with such parts and/or materials used in vehicle maintenance and/or repair. In at least some instances, the Inventory Logistics System 120 receives the data indicative of an identifier associated with such parts and/or materials used in vehicle maintenance and/or repair. Such data may identify any one of a number of geographically diverse locations where the fleet operator maintains an inventory of parts and/or materials intended for the maintenance and/or repair of the fleet operator's vehicles. Such data may identify with particularity a depot or warehouse location (e.g., aisle 5, row 3, bin 7) where a specific part or material needed for vehicle maintenance or repair may be found.

At 1106, the Inventory Logistics System 120 receives data indicative of one or more parts and/or materials required to repair or maintain one or more vehicles 102. In some instances, using analytical result data generated using acquired vehicle system data the Diagnostics System 130 either alone or in cooperation with the Inventory Logistics System 120, determines one or more parts and/or materials needed to repair or maintain a vehicle 102. After determining the parts and/or materials needed, the Diagnostics System 130 communicates all or a portion of the data indicative of the needed parts and/or materials to the Inventory Logistics System 120.

In some instances, using on acquired vehicle system data from one or more vehicles 102, the portable device 110 communicates all or a portion of the data indicative of one or more parts and/or materials required to repair or maintain one or more vehicles 102 to the Inventory Logistics System 120. In some instances, the portable device user communicates all or a portion of the data indicative of one or more parts and/or materials required to repair or maintain one or more vehicles 102 to the Inventory Logistics System 120.

At 1108, the Inventory Logistics System 120 determines the location of the parts and/or materials requested by the Diagnostic System 130, the portable device 110, and/or the portable device user. In addition, the Inventory Logistics System 120 may optionally determine the date when the needed parts will be available at the field location of the vehicle. The back-end system 210 communicates data indicative of the parts and/or materials needed to repair or maintain the vehicle 102, the time at which the parts and/or materials will be available, and optionally the location at which the parts and/or materials will be positioned to the portable device 110 associated with the respective vehicle 102. The method 1100 of determining the location of parts and/or materials needed for repair of one or more vehicles and specifying at least one of the date and time that the parts and/or materials are needed or a location where the parts and/or materials are needed concludes at 1110.

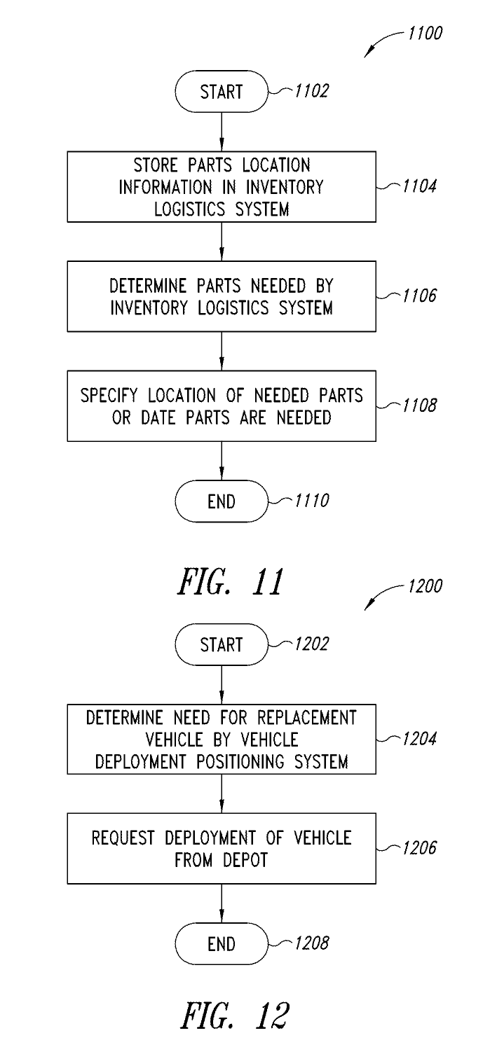

FIG. 12 is a logic diagram of an example method 1200 of determining the need for deployment of a replacement vehicle 102 based on the acquired vehicle system data and/or the acquired vehicle condition data provided by the portable device 110 associated with a particular vehicle 102. In some instances, the maintenance or repairs required to restore a field-positioned vehicle to operational service may exceed the limited capabilities of the crewmembers or field maintenance personnel assigned to the vehicle 102. In such instances, the back-end system 210 can determine the need for deployment of a replacement vehicle from a vehicle motor pool, warehouse, or depot. The method 1200 of determining the need for deployment of a replacement vehicle 102 based on the acquired vehicle system data and/or the acquired vehicle condition data provided by the portable device 110 associated with a particular vehicle 102 commences at 1202.

At 1204, the back-end system 210 determines the need for deployment of a replacement vehicle from a vehicle motor pool, warehouse, or depot based on received data indicative of field-positioned vehicle system data and/or field-positioned vehicle condition. In at least some instances, the Diagnostic System 130 can assess the data indicative of field-positioned vehicle system data and/or field-positioned vehicle condition to determine the need for deployment of a replacement vehicle from a vehicle motor pool, warehouse, or depot. For example, responsive to the receipt of data indicative of a comprehensive engine failure in a Challenger II main battle tank, the Diagnostic System 130 may determine the technical expertise of the crewmembers or maintenance personnel associated with the vehicle are insufficient to perform remedial engine repairs. In such instances, the Diagnostic System 130 can provide data to the Vehicle Deployment Positioning System 140 that includes the type and location of the vehicle.

At 1206, the Vehicle Deployment Positioning System 140 requests deployment of a replacement vehicle 102 from a vehicle motor pool, warehouse, or depot. In at least some instances, the Vehicle Deployment Positioning System 140 can transmit to the portable device 110 information indicative of the replacement vehicle identification, a time at which the replacement vehicle will be available, and/or a location at which the replacement vehicle will be available. The method 1200 of determining the need for deployment of a replacement vehicle 102 based on the acquired vehicle system data and/or the acquired vehicle condition data provided by the portable device 110 associated with a particular vehicle 102 concludes at 1208.

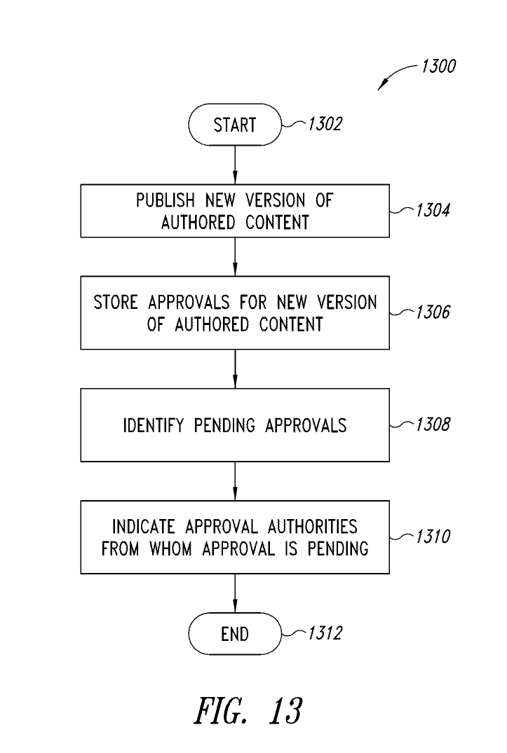

FIG. 13 is a logic diagram of an example method 1300 of publishing new versions of authored content, storing approvals for new versions of authored content and identifying those approval authorities from whom approval is pending. Vehicle manufacturers and equipment suppliers provide vehicle related authored content such as checklists and/or instruction sets 112 to support the ongoing maintenance and repair of vehicles supplied to fleet operators. This vehicle related authored content can be in electronic format and can include text, graphics, illustrations, animations, audio tracks, video presentations, and audio/video presentations geared towards the ongoing maintenance and repair of vehicles and/or other equipment provided by the manufacturer or supplier to the fleet operator. As equipment evolves, newer equipment models or versions may replace older equipment models or versions on an ongoing or rotating basis. Thus, at any time a vehicle fleet may include any number of different versions of the same make and model of vehicle (e.g., a fleet may include 2006 to 2013 GMC Sierra Pick-Ups, each having slightly different maintenance requirements or repair procedures reflective of the evolution of the Sierra pickup over the 8 year period from 2006 to 2013). Thus, although a number of “core” checklists and/or instruction sets 112 may apply across a number of vehicle versions, additional checklist and/or instruction set 112 may be required for some or all of the versions included in an operator's fleet. The method 1300 of tracking and approving various versions of vehicle related authored content commences at 1302.

At 1304, a vehicle manufacturer or equipment supplier publishes a new version of vehicle related authored content. Such vehicle related authored content may include one or more checklists and/or instruction sets 112 logically associated with a particular vehicle version (e.g., 2009 GMC Sierra pick-ups) included in the motor pool of a fleet operator. The vehicle manufacturer or equipment supplier physically or electronically transmits the new version of vehicle related content to a back-end system 210 for review and approval prior to general distribution via field-deployed portable devices carried by crewmembers or maintenance personnel. In at least some instances, the Authoring Versioning Approval System 150 can receive all or a portion of the vehicle related authored content published by the vehicle manufacturer or equipment supplier.

At 1306, the Authoring Versioning Approval System 150 forwards the received vehicle related authored content to one or more defined approval authorities for review and approval. Such an approval process may include multiple parallel approvals or a number of sequential approvals by various approval authorities within the fleet operator's administrative organization. As approvals are received from each of the approval authorities, the Authoring Versioning Approval System 150 stores data indicative of the approval in a nontransitory storage memory communicably coupled to the back-end system 210.

At 1308, the Authoring Versioning Approval System 150 identifies those approval authorities from whom approval for a new version of vehicle related authored content is pending.

At 1310, the Authoring Versioning Approval System 150 generates data indicative of one or more approval authorities from whom approval is pending. In at least some implementations, the Authoring Versioning Approval System 150 transmits notifications including a message reminding the approval authority of the new version of vehicle related authored content awaiting their approval. The method 1300 of tracking and approving various versions of vehicle related authored content concludes at 1312.

The various methods described herein may include additional acts, omit some acts, and/or may perform the acts in a different order than set out in the various flow diagrams.

For example, the communications described herein may take place of secure channels and/or may be encrypted, for instance employing public-private keys, hash algorithms, and hash codes. Communications may also employ various forms of authentication, including use of user names and passcode combinations, use of dongles, smartcards, or other media that store unique identification or authentication credentials. Communications may employ authentication certificates. Likewise, authored content may be communicated and/or stored in encrypted form, and may be protected via various authentication techniques. Such may, for example, include limiting access based on user identity or user role. For instance, a vehicle operator may have a limited level of access to a first set of authored content, while a vehicle mechanic may have a less limited level of access to the first set of authored content. Also for instance, the vehicle operator may have less limited level of access to a second set of authored content, while the vehicle mechanic may have more limited level of access to the second set of authored content. Levels of access may indicate whether a user has full read privileges, limited read privileges, full write privileges, limited write or annotation privileges, read/write privileges, copy or duplicate privileges, and/or delete privileges.

The foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via one or more microcontrollers. However, those skilled in the art will recognize that the embodiments disclosed herein, in whole or in part, can be equivalently implemented in standard integrated circuits (e.g., Application Specific Integrated Circuits or ASICs), as one or more computer programs executed by one or more computers (e.g., as one or more programs running on one or more computer systems), as one or more programs executed by on one or more controllers (e.g., microcontrollers), as one or more programs executed by one or more processors (e.g., microprocessors), as firmware, or as virtually any combination thereof, and that designing the circuitry and/or writing the code for the software and/or firmware would be well within the skill of one of ordinary skill in the art in light of the teachings of this disclosure.

When logic is implemented as software and stored in memory, logic or information can be stored on any non-transitory computer-readable medium for use by or in connection with any processor-related system or method. In the context of this disclosure, a memory is a nontransitory computer- or processor-readable storage medium that is an electronic, magnetic, optical, or other physical device or means that non-transitorily contains or stores a computer and/or processor program. Logic and/or the information can be embodied in any computer-readable medium for use by or in connection with an instruction execution system, apparatus, or device, such as a computer-based system, processor-containing system, or other system that can fetch the instructions from the instruction execution system, apparatus, or device and execute the instructions associated with logic and/or information.

In the context of this specification, a “computer-readable medium” can be any physical element that can store the program associated with logic and/or information for use by or in connection with the instruction execution system, apparatus, and/or device. The computer-readable medium can be, for example, but is not limited to, an electronic, magnetic, optical, electromagnetic, infrared, or semiconductor system, apparatus or device. More specific examples (a non-exhaustive list) of the computer readable medium would include the following: a portable computer diskette (magnetic, compact flash card, secure digital, or the like), a random access memory (RAM), a read-only memory (ROM), an erasable programmable read-only memory (EPROM, EEPROM, or Flash memory), a portable compact disc read-only memory (CDROM), and digital tape.

The various embodiments described above can be combined to provide further embodiments. Aspects of the embodiments can be modified, if necessary, to employ systems, circuits and concepts of the various patents, applications and publications to provide yet further embodiments.

While generally discussed in the environment and context of power system for use with personal transportation vehicle such as all-electric scooters and/or motorbikes, the teachings herein can be applied in a wide variety of other environments, including other vehicular as well as non-vehicular environments.

The above description of illustrated embodiments, including what is described in the Abstract, is not intended to be exhaustive or to limit the embodiments to the precise forms disclosed. U.S. provisional application Ser. No. 61/877,646, filed Sep. 13, 2013; U.S. provisional application Ser. No. 61/861,887, filed Aug. 2, 2013; and U.S. provisional application Ser. No. 61/865,463, filed Aug. 13, 2013 are each incorporated herein by reference in their entireties. Although specific embodiments and examples are described herein for illustrative purposes, various equivalent modifications can be made without departing from the spirit and scope of the disclosure, as will be recognized by those skilled in the relevant art.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A vehicle operation computer device, comprising:
a control subsystem including at least one processor and at least one nontransitory processor-readable medium communicatively coupled to the at least one processor;
a user interface subsystem communicatively coupled to the control subsystem, the user interface subsystem including at least one input device; and
a communications subsystem communicatively coupled to the control subsystem, the communications subsystem operable to selectively provide communications with at least one external device,
the control subsystem causes the user interface subsystem to provide at least one checklist which is specific to a make and model of the vehicle, stores information received via the checklist and the user interface subsystem, and the communications subsystem selectively transmits the stored information logically associated with a unique vehicle identifier that uniquely identifies the vehicle.

2. The vehicle operation computer device of claim 1 wherein the communications subsystem selectively transmits the stored information logically associated with a unique user identifier that uniquely identifies a user of the vehicle operation computer device.

3. The vehicle operation computer device of claim 1 wherein the control subsystem determines a role of a user of the vehicle operation tablet computer device, and selects the checklist from a library of checklists based at least in part on the determined role of the user.

4. The vehicle operation computer device of claim 3 wherein the control subsystem determines the role of a user of the vehicle operation computer device from a set of roles including vehicle operator, vehicle technician, and mechanic.

5. The vehicle operation tablet computer device of claim 3 wherein the control subsystem determines the role of a user of the vehicle operation computer device from at least one input by the user.

6. The vehicle operation tablet computer device of claim 3 wherein the control subsystem determines the role of a user of the vehicle operation tablet computer device from at least one automatically sensed parameter (e.g., RFID, biometric) indicative of an identity of the user of the vehicle operation computer device.

7. The vehicle operation tablet computer device of claim 1 wherein the vehicle operation computer device takes the form of a vehicle operation tablet computer device and the at least one input device includes at least one touch-sensitive display, which in use displays at least one user interface component.

8. The vehicle operation computer device of claim 7 wherein the at least one user interface component includes at least one of a selectable icon or text.

9. The vehicle operation computer device of claim 7 wherein the at least one user interface component includes at least one fillable form.

10. The vehicle operation computer device of claim 1 wherein the communications subsystem transmits the stored information logically associated with the unique vehicle identifier when both: a) a wireless communications connection is available via the communications subsystem, and b) the vehicle is not in a radio dark mode.

11. The vehicle operation computer device of claim 1 wherein the communications subsystem transmits the stored information logically associated with the unique vehicle/equipment identifier when a tethered communications connection is available via the communications subsystem.

12. The vehicle operation computer device of claim 1 wherein the control subsystem causes the user interface subsystem to provide a synchronization message.

13. The vehicle operation computer device of claim 12 wherein the control subsystem causes the user interface subsystem to provide the synchronization message in response to detection of a tethered or untethered communications channel accessible via the communications subsystem.

14. The vehicle operation computer device of claim 12 wherein the control subsystem causes the user interface subsystem to provide the synchronization message in response to a scheduled synchronization.

15. The vehicle operation computer device of claim 12 wherein the control subsystem causes the user interface subsystem to provide the synchronization message in response to a period between a current date and a most recent synchronization exceeding a threshold value.

16. The vehicle operation computer device of claim 12 wherein the control subsystem causes the user interface subsystem to provide the synchronization message in response to both a) a period between a current date and a most recent synchronization exceeding a threshold value, and b) a tethered or untethered communications channel is accessible via the communications subsystem.

17. The vehicle operation computer device of claim 1 wherein the control subsystem deletes the stored information from the nontransitory processor-readable medium after the communications subsystem transmits the information.

18. The vehicle operation computer device of claim 1 wherein the control subsystem locks the stored information in the nontransitory processor-readable medium from changes in response to an event.

19. The vehicle operation computer device of claim 1 wherein the communications subsystems receives signals indicative of one or more automatically sensed conditions of the vehicle, and the communications subsystem automatically transmits information indicative of the automatically sensed conditions of the vehicle externally from the vehicle operation computer device.

20. The vehicle operation computer device of claim 1 wherein the communications subsystems receives signals indicative of one or more automatically sensed conditions of the vehicle, and the control subsystem automatically populates at least a portion of the checklist based at least in part on the automatically sensed conditions of the vehicle.

21. The vehicle operation computer device of claim 19 wherein the communications subsystems receives the signals from a controller area network (CAN) bus of the vehicle.

22. The vehicle operation computer device of claim 19 wherein communications subsystems receives the signals from at least one transceiver that is directly communicatively coupled to a controller area network (CAN) bus of the vehicle.

23. The vehicle operation computer device of claim 19 wherein the signals are indicative of at least one of: an engine speed, an engine temperature, an oil pressure of the vehicle.

24. The vehicle operation computer device of claim 19 wherein the signals are indicative of at least one of: an ambient environmental characteristic at least proximate the vehicle.

25. A method of operating a vehicle operation computer device, comprising:
identifying a vehicle make and a vehicle model on a vehicle operation computing device;
generating by the vehicle operation computing device a user interface, the user interface including at least one vehicular checklist specific to the identified vehicular make and the identified vehicular model;
receiving one or more inputs by the vehicle operation computing device, the one or more inputs including data indicative of information provided responsive to the at least one vehicular checklist;
storing in a nontransitory storage medium communicably coupled to the vehicle operation computing device the received data indicative of information provided responsive to the at least one vehicular checklist; and
transmitting the stored data indicative of information provided responsive to the at least one vehicular checklist along with data representative of a unique vehicle identifier that uniquely identifies a vehicle logically associated with the at least one vehicular checklist to one or more remote recipient devices.

26-48. (canceled)

49. A system to facilitate operation of vehicles, comprising:
an authoring system, the authoring system including at least one authoring system processor and at least one authoring system nontransitory processor-readable medium communicatively couple to the at least one authoring system processor, and an authoring system communications subsystem operable to selectively provide communications, the at least one authoring system processor operable to generate a number of versions of vehicle related authored content, and to at least temporarily store the versions of vehicle related authored content to the at least one authoring system nontransitory processor-readable medium at least until each version of the vehicle related authored content is approved; and
an authored content distribution system, including at least one authored content distribution processor and at least one authored content distribution nontransitory processor-readable medium communicatively couple to the at least one authored content distribution processor, and an authored content distribution communications subsystem operable to selectively provide networked communications at least with a plurality of end user devices, the authored content distribution processor operable to track approval of versions of the vehicle related authored content and the authored content distribution communications subsystem which provides approved versions of the vehicle related authored content remotely from the authored content distribution system to each of the plurality of end user devices.

50-84. (canceled)

85. A method of facilitating operation of vehicles, comprising:
generating by an authoring system a number of versions of vehicle related authored content;
at least temporarily storing in a nontransitory storage medium communicably coupled to the authoring system the number of versions of vehicle related authored content at least until each version of the vehicle related authored content is approved by at least one approval authority;
providing by an authored content distribution system communicably coupled to the authoring system, networked communications at least with a plurality of end user devices;
tracking by the authored content distribution system an approval by the least one approval authority of at least one of the number of versions of the vehicle related authored content; and
distributing the approved versions of the vehicle related authored content to each of the plurality of end user devices.

86-120. (canceled)
